(19) United States
(12) Patent Application Publication
(10) Pub. No.: US 2016/0103912 A1
(43) Pub. Date: Apr. 14, 2016

(54) METHOD FOR DETERMINING AND REPRESENTING A DATA ONTOLOGY

(71) Applicant: UNIVERSITY OF WASHINGTON THROUGH ITS CENTER FOR COMMERCIALIZATION, Seattle, WA (US)

(72) Inventors: Valerie DAGGETT, Seattle, WA (US); Dennis BROMLEY, Seattle, WA (US); Steven RYSAVY, Seattle, WA (US)

(21) Appl. No.: 14/891,722

(22) PCT Filed: Jun. 27, 2014
(86) PCT No.: PCT/US2014/044683

§ 371 Date: Nov. 17, 2015

Related U.S. Application Data
(60) Provisional application No. 61/840,617, filed on Jun. 28, 2013.

(51) Int. Cl. G06F 17/30; G06F 19/00

(52) U.S. Cl. CPC G06F 17/30734; G06F 19/3443

(57) ABSTRACT

Methods and apparatus are provided for representing structured information. A computing device can receive data from data sources. The computing device can generate a data frame that includes data items based on the received data. The computing device can determine a data ontology, where the data ontology can include datanodes. The computing device can determine data pins which include a first data pin. The first data pin can include a first reference and a second reference. The first reference can refer to a first data item in the data frame and the second reference can refer to a first datanode of the plurality of datanodes. The first datanode can be related to the first data item. The computing device can obtain data for the first data item at the first datanode via the first data pin and then can provide a representation of the data ontology.

### CROSS-REFERENCE TO RELATED APPLICATIONS

The present application claims priority to U.S. Provisional Patent Application No. 61/840,617, entitled “Methods for Efficient Streaming of Structured Information”, filed Jun. 28, 2013, which is entirely incorporated by reference herein for all purposes.

### STATEMENT OF GOVERNMENT RIGHTS

This invention was made with government support under Grant Nos. 5T15LM007442 and GM50789, awarded by the National Institutes of Health. The government has certain rights in the invention.

### BACKGROUND

The advent of massive networked computing resources has enabled virtually unlimited data collection, storage and analysis for projects such as low-cost genome sequencing, high-precision molecular dynamics simulations and high-definition imaging data for radiology, to name just a few examples. The resulting large, complex datasets known as “big data” make data processing difficult or impossible using database management software from one computer. Big data are becoming increasingly present in many aspects of society and technology including health care, science, industry and government. Many of these large, complex data sets are best understood when analyzed in a structured manner.

One such structured manner is to use an ontology for a data set, which is a structured representation of the data in that data set. Although not new per se, the use of ontologies is growing in the presence of modern computer technologies. For example, the semantic web is a very compelling, yet nascent and underdeveloped, example use of ontologies for data sets. The paradigms of big data and ontologies are likely to become more important. These paradigms have worked well together, such as in the field of visual analytics, which uses interactive visual techniques to interact with big data.

Ontologies also enable formal analysis, which helps with semantic correctness, interoperability, and can bring much needed insight. Ontologies can be applied to complex, multi-dimensional, and/or large data sets. But the development of data-specific, formal ontologies can be very difficult.

### SUMMARY

In one aspect, a method is provided. A computing device receives data from one or more data sources. The computing device generates a data frame based on the received data. The data frame includes a plurality of data items. The computing device determines a data ontology, where the data ontology includes a plurality of datanodes. The computing device determines a plurality of data pins. A first data pin of the plurality of data pins includes a first reference and a second reference. The first reference for the first data pin refers to a first data item in the data frame and the second reference for the first data pin refers to a first datanode of the plurality of datanodes. The first datanode is related to the first data item. The computing device obtains data for the first data item at the first datanode of the data ontology via the first data pin. The computing device provides a representation of the data ontology.

In another aspect, a computing device is provided. The computing device includes a processor and a tangible computer readable medium. The tangible computer readable medium is configured to store at least executable instructions. The executable instructions, when executed by the processor, cause the computing device to perform functions including: receiving data from one or more data sources; generating a data frame based on the received data, the data frame including a plurality of data items; determining a data ontology, where the data ontology includes a plurality of datanodes; determining a plurality of data pins, where a first data pin of the plurality of data pins includes a first reference and a second reference, where the first reference for the first data pin refers to a first data item in the data frame, where the second reference for the first data pin refers to a first datanode of the plurality of datanodes, and where the first datanode is related to the first data item; obtaining data for the first data item at the first datanode of the data ontology via the first data pin; and providing a representation of the data ontology.

In another aspect, a tangible computer readable medium is provided. The tangible computer readable medium is configured to store at least executable instructions. The executable instructions, when executed by a processor of a computing device, cause the computing device to perform functions including: receiving data from one or more data sources; generating a data frame based on the received data, the data frame including a plurality of data items; determining a data ontology, where the data ontology includes a plurality of datanodes; determining a plurality of data pins, where a first data pin of the plurality of data pins includes a first reference and a second reference, where the first reference for the first data pin refers to a first data item in the data frame, where the second reference for the first data pin refers to a first datanode of the plurality of datanodes, and where the first datanode is related to the first data item; obtaining data for the first data item at the first datanode of the data ontology via the first data pin; and providing a representation of the data ontology.

In another aspect, a device is provided. The device includes means for receiving data from one or more data sources; means for generating a data frame based on the received data, the data frame including a plurality of data items; means for determining a data ontology, where the data ontology includes a plurality of datanodes; means for determining a plurality of data pins, where a first data pin of the plurality of data pins includes a first reference and a second reference, where the first reference for the first data pin refers to a first data item in the data frame, where the second reference for the first data pin refers to a first datanode of the plurality of datanodes, and where the first datanode is related to the first data item; means for obtaining data for the first data item at the first datanode of the data ontology via the first data pin; and means for providing a representation of the data ontology.

### BRIEF DESCRIPTION OF THE DRAWINGS

FIG. 1 shows a high-level representation of the DIVE system receiving data from data sources, in accordance with an embodiment.

FIG. 2 shows an example architecture for the DIVE system, in accordance with an embodiment.

FIG. 3 shows a pipeline between data sources and the DIVE system, in accordance with an example embodiment.

FIG. 4 shows a DIVE object parser having converted a software object hierarchy to a DIVE data structure, in accordance with an embodiment.

FIG. 5 shows a scenario where the DIVE object parser has translated a code assembly into two ontologies, in accordance with an example embodiment.

FIG. 6 shows examples of interactive SQL streaming and pass-through SQL streaming, in accordance with an example embodiment.

FIG. 7 shows an example protein simulated using molecular dynamics, in accordance with an embodiment.

FIG. 8 shows a data flow using the DIVE system for the Dynameomics project, in accordance with an example embodiment.

FIG. 9 shows an example view of a Protein Dashboard, in accordance with an embodiment.

FIGS. 10A and 10B show visualizations related to the respective p53 and SOD1 proteins provided by the DIVE system, in accordance with an embodiment.

FIG. 11 shows example DIVE pipelines, in accordance with an embodiment.

FIG. 12 is a block diagram of an example computing network, in accordance with an embodiment.

FIG. 13A is a block diagram of an example computing device, in accordance with an embodiment.

FIG. 13B depicts an example cloud-based server system, in accordance with an embodiment.

FIG. 14 is a flow chart of an example method, in accordance with an embodiment.

### DETAILED DESCRIPTION

### Efficient Streaming of Structured Information

Many modern large-scale projects, such as scientific investigations for bioinformatics research, are generating big data. The explosion of big data is changing traditional scientific methods; instead of relying on experiments to output relatively small targeted datasets, data mining techniques are being used to analyze data stores with the intent of learning from the data patterns themselves. Data analysis and integration in large data storage environments can challenge even experienced scientists.

Many of these large datasets are complex, heterogeneous, and/or incomplete. Most existing domain-specific tools designed for complex heterogeneous datasets are not equipped to visually analyze big data. For example, while powerful scientific toolsets are available, including software libraries such as SciPy, specialized visualization tools such as Chimera, and scientific workflow tools such as Taverna, Galaxy, and the Visualization Toolkit (VTK), some toolsets cannot handle large datasets. Other toolkits have not been updated to handle recent advances in data generation and acquisition.

DIVE (Data Intensive Visualization Engine) was designed and developed to help fill this technological gap. DIVE includes a software framework intended to facilitate analysis of big data and reduce the time to derive insights from the big data. DIVE employs an interactive, extensible, and adaptable data pipeline to apply visual analytics approaches to heterogeneous, high-dimensional datasets. Visual analytics is a big data exploration methodology emphasizing the iterative process between human intuition, computational analyses and visualization. DIVE's visual analytics approach integrates with traditional methods, creating an environment that supports data exploration and discovery.

DIVE provides a rich ontologically expressive data representation and a flexible modular streaming-data architecture or pipeline. The DIVE pipeline is accessible to users and software applications through an application programming interface, command line interface or graphical user interface. Applications built on the DIVE framework inherit features such as a serialization infrastructure, ubiquitous scripting, integrated multithreading and parallelization, object-oriented data manipulation and multiple modules for data analysis and visualization. DIVE can also interoperate with existing analysis tools to supplement its capabilities by either exporting data into known formats or by integrating with published software libraries. Furthermore, DIVE can import compiled software libraries and automatically build native ontological data representations, reducing the need to write DIVE-specific software. From a data perspective, DIVE supports the joining of multiple heterogeneous data sources, creating an object-oriented database capable of showing inter-domain relationships.

A core feature of DIVE's framework is the flexible graph-based data representation. DIVE data are stored as datanodes in a strongly typed ontological network defined by the data. These data can range from a set of unordered numbers to a complex object hierarchy with inheritance and well-defined relationships. Datanodes are software objects that can update both their values and structures at runtime. Furthermore, the datanodes' ontological context can change during runtime. So, DIVE can explore dynamic data sources and handle the impromptu user interactions commonly required for visual analysis.

Data flow through the system explicitly as a set of datanodes passed down the DIVE pipeline or implicitly as information transferred and transformed through the data relationships. Data from any domain may enter the DIVE pipeline, allowing DIVE to operate on a wide variety of datasets, such as, but not limited to, protein simulations, gene ontology, professional baseball statistics, and streaming sensor data.

Besides simply representing the conceptual structure of the user's dataset, DIVE's graph-based data representation can effectively organize data. For example, using DIVE's object model, ontologies from disparate sources can be merged. Each ontology can be represented as DIVE datanodes and dataedges. Then, the ontologies can be merged through property inheritance. This allows ontologies to inherit definitions from each other, resulting in a new, merged ontology compatible with multiple data sources and amenable to new analytical approaches.

DIVE includes a DIVE object parser with the ability to parse a .NET object or assembly distinct from the DIVE framework. Use of the DIVE object parser can circumvent addition of DIVE-specific code to existing programs. Further, the DIVE object parser can augment those programs with DIVE capabilities such as graphical interaction and manipulation. In one example (the Dynameomics API), the underlying data structures and the streaming functionality were integrated into a Protein Dashboard tool using the DIVE object parser without modifying the existing API code base, enabling reuse of the same code base in the DIVE framework and in Structured Query Language (SQL) Common Language Runtime implementations and other non-DIVE utilities.

DIVE supports two general techniques for data streaming: interactive SQL and pass-through SQL. Interactive SQL can effectively provide a flexible visualization frontend for an SQL database or data warehouse. However, for datasets not immediately described by the underlying database schema or other data source, the pass-through SQL approach can be used to stream complex data structures. Use of the pass-through SQL approach can enable use of very large scale datasets. For example, the pass-through SQL approach allowed DIVE to make hundreds of terabytes of structured data immediately accessible to users in a Dynameomics case study. These data can be streamed into datanodes and can be accessed either directly or indirectly through the associated ontology (for example, through property inheritance). Furthermore, these data are preemptively loaded via background threads into backing stores; these backing stores are populated using efficient bulk transfer techniques and predictively cache data for user consumption.

Finally, when the object parser is used with pass-through SQL, methods as well as data are parsed. So, the datanodes can access native .NET functionality in addition to the streaming data. Preexisting programs also can benefit from DIVE's streaming capabilities. For example, Chimera can open a network socket to DIVE's streaming module. This lets Chimera stream MD data directly from the Dynameomics data warehouse.

Overall, DIVE provides an interactive data-exploration framework that expands on conventional analysis paradigms and self-contained tools. DIVE can adapt to existing data representations, consume non-DIVE software libraries and import data from an array of sources. As research becomes more data-driven, fast, flexible big data visual analytics solutions, such as the herein-described DIVE, can provide a new perspective for projects using large, complex data sets.

### DIVE Architecture

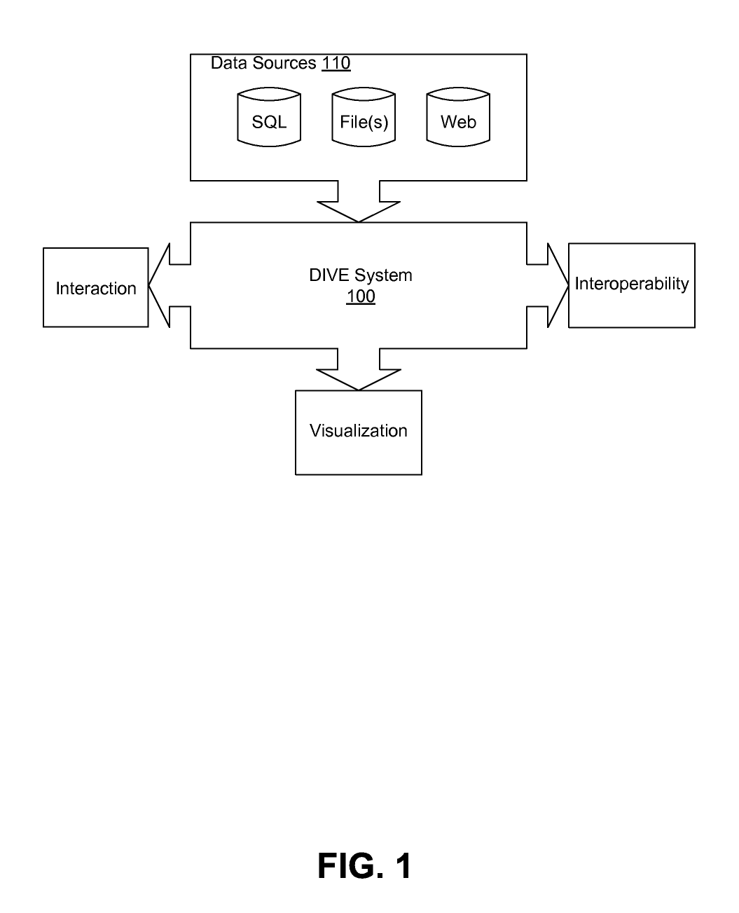

FIG. 1 shows a high-level representation of the DIVE system 100 receiving data from data sources 110, in accordance with an embodiment. DIVE system 100 can provide interaction, interoperability, and visualization of data received from data sources 110. DIVE system 100 includes an API whose primary component is the data pipeline, for streaming, transforming, and visualizing large, complex datasets at interactive speeds. The pipeline can be extended with plug-ins; each plug-in can operate independently on the data stream of the pipeline.

FIG. 1 shows example data sources 110 can be accessed using the SQL format. Data sources 110 can include both local data sources (e.g., a data source whose data is stored on a computer running software for DIVE system 100) and remote data sources, such as databases and files with data. In some embodiments, DIVE system 100 can support additional and/or different languages than SQL to access data in data sources 110; e.g., Contextual Query Language (CQL), Gellish English, MQL, Object Query Language (OQL), RDQL, SMARTS.

Interaction can be provided by DIVE system 100 providing visual analytics and/or other tools for exploration of data from data sources 110. Interoperability can be provided by DIVE system 100 providing data obtained from data sources 110 in a variety of formats to DIVE plug-ins, associated applications, and DIVE tools.

These plug-ins, applications, and tools can be organized via the data pipeline. As one example, a DIVE tool can start a DIVE pipeline to convert data in a data frame into an ontological representation using a first DIVE plug-in, an application can generate renderable data from the ontological representation, and then a second DIVE plug-in can enable interaction with the renderable data.

The DIVE pipeline can be used to arrange components in a sequence of pipeline stages. An example three-stage DIVE pipeline using the above-mentioned components can include:

Stage 1—the first DIVE plug-in receives data from data sources 110, generates corresponding ontological representations, and outputs the ontological representations onto the pipeline.
Stage 2—the application receives the ontological representations as inputs via the pipeline, generates renderable data, and outputs the renderable data onto the pipeline.
Stage 3—the second DIVE plug-in can receive the renderable data via the pipeline and present the renderable data for interaction.
Additional DIVE pipeline examples are possible as well—some of these additional examples are discussed herein.

DIVE is domain independent and data agnostic. The DIVE pipeline accepts data from any domain, provided an appropriate input parser is implemented. Some example data formats supported by DIVE include, but are not limited to, SQL, XML, comma- and tab-delimited files, and several other standard file formats. In some embodiments, DIVE can utilize functionality from an underlying software infrastructure, such as a UNIX™-based system or the .NET environment.

Ontologies are gaining popularity as a powerful way to organize data. DIVE system 100's core data representation using datanodes and dataedges was developed with ontologies in mind. The fundamental data unit in DIVE is the datanode, where datanodes can be linked using dataedges.

Datanodes somewhat resemble traditional object instances from object-oriented (OO) languages such as C++, Java, or C#. For example, datanodes are typed, contain strongly typed properties and methods, and can exist in an inheritance hierarchy. Datanodes extend the traditional model of object instances, as datanodes can exist outside of an OO environment; e.g., in an ontological network or graph, and can have multiple relationships beyond simple type inheritance. DIVE system 100 implements these relationships between datanodes using dataedges to link related datanodes. Dataedges can be implemented by datanode objects and consequently might contain properties, methods, and inheritance hierarchies. Because of this basic flexibility, DIVE system 100 can represent arbitrary, typed relationships between objects, objects and relationships, and relationships and relationships.

Datanodes are also dynamic; every method and property can be altered at runtime, adding flexibility to DIVE system 100. The DIVE pipeline contains various data integrity mechanisms to prevent unwanted side effects. The inheritance model is also dynamic; as a result, objects can gain and lose type qualification and other inheritance aspects at runtime. This allows runtime classification schemes such as clustering to be integrated into the object model.

Datanodes of DIVE system 100 provide virtual properties. These properties are accessed identically to fixed properties but store and recover their values through arbitrary code instead of storing data on the datanode object. Virtual properties can extend the original software architecture's functionality, e.g., to allow data manipulation.

Dataedges can be used to implement multiple inheritance models. Besides the traditional is-a relationship in object-oriented (OO) languages, ontological relationships such as contains, part-of, and bounded-by can be expressed. Each of these relationships can support varying levels of inheritance:
With OO inheritance, which is identical to OO languages such as C++ and Java, subclasses inherit the parent's type, properties, and methods; e.g., a triangle is a polygon.
With type inheritance, subclasses inherit only the type; type inheritance is used to implement OO languages.
With property inheritance, subclasses inherit only the properties and methods; e.g., a polygon contains line segments.

Like OO language objects, property-inheritance subclasses can override superclass methods and properties with arbitrary transformations. Similarly, type-inheritance subclasses can be cast to superclass types. Because DIVE system 100 supports not only multiple inheritance but also multiple kinds of inheritance, casting can involve traversing the dataedge ontology. Owing to the coupling of the underlying data structure and ontological representation, every datanode and dataedge is implicitly part of a system-wide graph. Then, graph-theoretical methods can be applied to analyze both the data structures and ontologies represented in DIVE system 100. This graph-theoretical approach has already proved useful in some examples; e.g., application of DIVE system 100 to structural biology.

DIVE system 100 supports code and tool reuse. Because all data are represented by datanodes and dataedges, DIVE analysis modules are presented with a syntactically homogenous dataset. Owing to this data-type independence, modules can be connected so long as the analyzed datanodes have the expected properties, methods, or types.

Data-type handling is a challenge in modular architectures. For examples, Taverna uses typing in the style of MIME (Multipurpose Internet Mail Extensions), the VTK uses strongly typed classes, and Python-based tools, such as Biopython and SciPy, often use Python's dynamic typing.

For DIVE system 100, the datanode and dataedge ontological network is a useful blend of these approaches. The dynamic typing of individual datanodes and dataedges lets us build arbitrary type networks from raw data sources. The underlying strong typing of the actual data (doubles, strings, objects, and so on) facilitates parallel processing, optimized script compilation, and fast, non-interpreted handling for operations such as filtering and plotting. Datanodes and dataedges themselves can be strongly typed objects to facilitate programmatic manipulation of the dataflow itself. Although each typing approach has its strengths, typing by DIVE system 100 lends itself to fast, agile data exploration and fast, agile updating of DIVE tools. The datanode objects' homogeneity also simplifies the basic pipeline and module development. The tool updating is a particularly useful feature in an academic laboratory where multiple research foci, a varied spectrum of technical expertise, and high turnover are all common.

Data can be imported into DIVE system 100 to make the data accessible to the DIVE pipeline. In some cases, DIVE system 100 includes built-in functionality for importing data. For tabular data or SQL data tables, DIVE system 100 can construct one datanode per row, and each datanode has one property per column. DIVE also supports obtaining data from Web services such as the Protein Data Bank. Once DIVE obtains the data for data nodes, DIVE can establish relationships between datanodes using dataedges.

The DIVE pipeline can utilize plug-ins to create, consume, or transform data. A plug-in can include a compiled software library whose objects inherit from a published interface to the DIVE pipeline. Plug-ins can move data through “pins” much like an integrated circuit: data originate at an upstream source pin and are consumed by one or more downstream sink pins. Plug-ins can also move data by broadcasting and receiving events. Users can save pipeline topologies and states as saved pipelines and also share saved pipelines. DIVE system 100 can provide subsequent plug-in connectivity, pipeline instantiation, scripting, user interfaces, and other aspects of plug-in functionality.

When DIVE system 100 sends a datanode object through a branching, multilevel transform pipeline, correctness of the datanode's property value(s) should be maintained at each pipeline stage. For example, a simple plug-in that scaled its incoming values could scale all incoming data values everywhere in the pipeline. One option to ensure datanode correctness is to copy all datanodes at every pipeline stage. This option can be computational-resource intensive and can delay a user from interacting with the datanodes.

Another option to address the correctness problem is to create a version history of each transformed value of a datanode. For example, DIVE system 100 can use read and write contexts to maintain the version history; e.g., values of a datanode can be saved before and after writing by the pipeline. The version history can be keyed on each pipeline stage. Then, each plug-in can reads only the appropriate values for its pipeline stage and does read values from another pipeline stage or branch. The use of version histories can be fast and efficient because upstream graph traversal is linear and each value lookup in a read or write context is a constant time operation. Use of version histories maintains data integrity in a branching transform pipeline as well as being parallelizable. Further, the use of read and write contexts can accurately track a property value at every stage in the pipeline with a minimum of memory use.

In some embodiments, DIVE system 100 can utilize the Microsoft Windows platform including the .NET framework, as this platform includes dynamic-language runtime, expression trees, and Language-Integrated Query (LINQ) support. The .NET framework can provide coding features such as reflection, serialization, threading, and parallelism for DIVE. These capabilities can affect DIVE's functionality and user experience. Support for dynamic languages allows flexible scripting and customization. LINQ can be useful in a scripted data-exploration environment. Expression trees and reflection can provide object linkages for the DIVE object parser. DIVE streaming can use the .NET framework's threading libraries. DIVE system 100 can use 64-bit computations and parallelism supported by .NET to scale as processor capabilities scale. In other embodiments, DIVE can utilize one or more other platforms that provide similar functionality as described as being part of the Windows platform and .NET framework.

The platform can support several software languages; e.g., C#, Visual Basic, F#, Python, and C++. Such platform support enables authoring DIVE plug-ins in the supported languages. In addition, the supported languages can be used for writing command-line, GUI, and programmatic tools for DIVE system 100. DIVE can use external libraries that are compatible with the platform, including molecular visualizers, clustering and analysis packages, charting tools, and mapping software; e.g., the VTK library wrapped by the ActiViz .NET API. In some embodiments, DIVE can draw on data base support provided by the platform; e.g., storing data in a Microsoft SQL Server data warehouse.

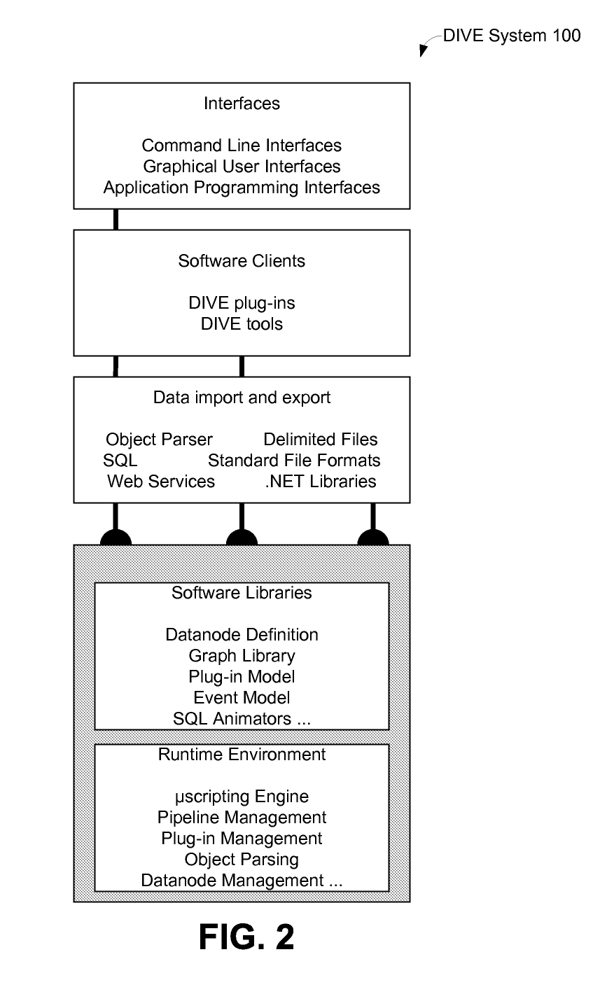

FIG. 2 shows an example architecture for DIVE system 100, in accordance with an embodiment. DIVE system 100 can include both software libraries and a runtime environment, as shown in the bottom of FIG. 2. DIVE system 100 can import and export data and functionality from a variety of sources, such as the DIVE object parser, SQL, Web Services, files, file formats, and libraries, as shown in the middle of FIG. 2.

Software clients of DIVE system 100 can include DIVE plug-ins and DIVE tools, as shown in FIG. 2, DIVE plug-ins can use DIVE software libraries to exploit DIVE's data handling capabilities. DIVE tools can include applications that manage a DIVE pipeline to solve one or more tasks; that is, the DIVE tool can instantiate, launch, and close a DIVE pipeline. In conjunction, DIVE tools can manage and build DIVE pipelines using DIVE plug-ins, applications, and perhaps even other DIVE tools associated with DIVE system 100. DIVE system 100 provides both user interfaces; e.g., command line interfaces (CLIs), graphical user interfaces (GUIs), and programmatic interfaces for software; e.g., one or more DIVE application programming interfaces (APIs).

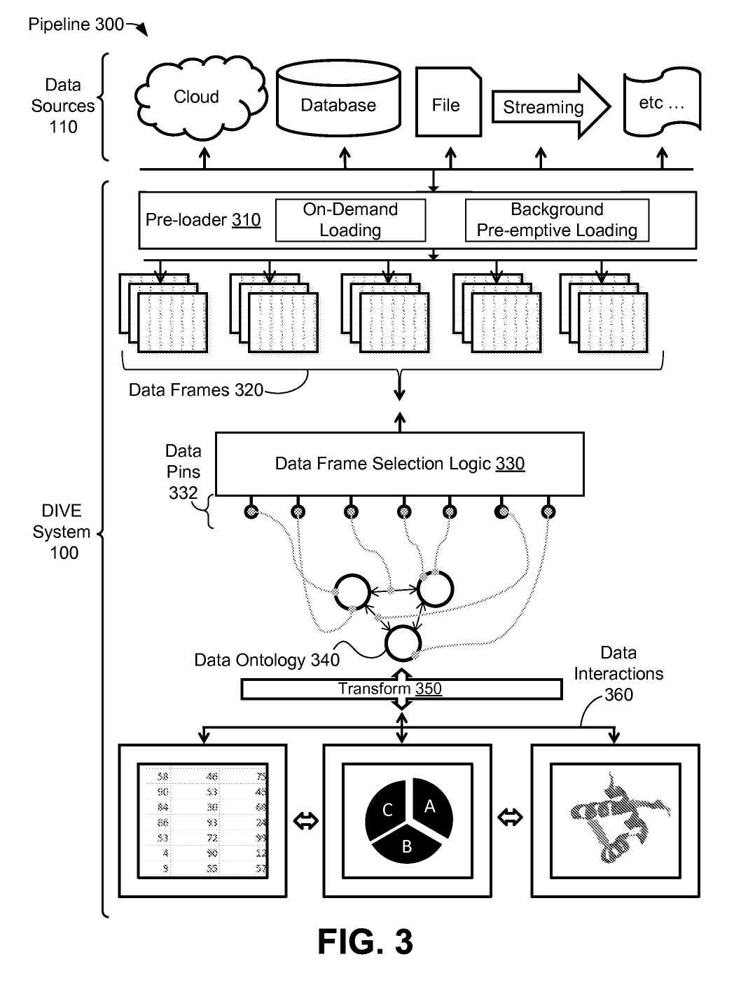

FIG. 3 shows a pipeline 300 between data sources 110 and DIVE system 100, in accordance with an example embodiment. In pipeline 300, data from data sources 110 is first received at DIVE system 100 by pre-loader 310. Pre-loader 310 for DIVE system 100 can facilitate big data operations. Traversing big data in an efficient manner is important for current and future big data interaction paradigms such as visual analytics. However, many big data operations can be slow; e.g., querying data from a big data source, representing data from big data source(s) in a complex ontology, and building subsets of represented data for visualization.

To speed big data operations, pre-loader 310 can predict user needs, perform on-demand and/or pre-emptive loading of corresponding data frames 320; e.g., subsets of data from one or more of data sources 110, and subsequent caching of loaded data frames 320. Each data frame of data frames 320 can include one or more data items, where each data item can include data in the subset(s) of data from one or more of data sources 110. For example, if an pre-loader 310 is loading data from data sources 110 related to purchases at a department store into data frame DF1 of data frames 320, each data frame, including DF1, can have data items (values) for data having data types such as “Purchased Item”, “Quantity”, “Item Price”, “Taxes”, “Total Price”, “Discounts”, and “Payment Type”.

Preemptive loading can reduce to on-demand loading of a specified frame, if necessary. Caching can be take place locally or remotely and can be single- or multi-tiered. For example, caching can include remote caching on a cloud database, which feeds local caching in local computer memory. In some embodiments, the local computer memory can include random access memory (RAM) chips, processor or other cache memory, flash memory, magnetic media, and/or other memory resident on a computing device executing software of DIVE system 100.

Loaded and cached data from data sources 110 can be stored by pre-loader 310 as data frames 320. Data frames 320 can be stored where they can be quickly accessed by the local computer memory.

Data frame selection logic 330 can include logic for switching relationships between data frames 320 and data pins 332. For example, data selection logic 330 can switch some or all of data pins 332 to reference data from a selected frame of frames 320. Data frame selection logic 330 can be provided by user input, programmatic logic, etc. In some embodiments, a pin-switching process for switching data pins 332 between frames of data frames 320 is O(1).

Once switched to a frame, data pins 332 can pull data, such as data items, from one or more selected data frames. In some embodiments, all pins reference one data frame, while in other embodiments, pins can reference two or more data frames; e.g., a first bank, or subset, of data pins 332 can reference the selected data frame F1 and a second bank of data pins 332 can reference a previously selected frame. Then, when a new data frame F2 is selected, the first bank of data pins 332 can reference the new frame F2 and the second bank of data pins 332 can reference the previously selected frame F1, or perhaps some other previously selected frame.

In some examples, one or more data pins of data pins 332 can be designated as a control pin. The control pin can indicate a control, or one or more data items of interest of the plurality of data items. For example, if data frames are each associated with a time, a control pin can indicate a time of interest a control, two control pins can respectively indicate a beginning time of interest and an ending time of interest for a time-range control, and multiple control pins can indicate multiple time/ranges of interest. As another example, if data frames are each associated with unique identifiers (IDs) such as serial numbers, VINs, credit card numbers, etc., a control pin can specify an ID of interest as a control. As another example, if data frames are each associated with a location, the location for the data frame can be used as a control. Many other examples of controls and control pins are possible as well.

In some examples, the control pin can be writeable so a user could set the control pin data; e.g., specify the control associated with the control pin (e.g., specify a time or ID). Then, once a control has been specified, DIVE system 100 can search or otherwise scan the data from data sources 100 for data related to the control. In other examples, the control pin can be read-only; that is, indicate a value of the control in a data frame, without allowing the control to be changed.

Data in data frames 320 can be organized according to data ontology 340, which can include arbitrary node types and arbitrary edges. Data ontology 340, in turn, can map node and edge properties; e.g., datanodes and dataedges, to data pins 332. When data pins 332 are switched between frames, data throughout ontology 340 that refers to data pins 332 can be simultaneously updated. For example, suppose data pin #1 referred to a data item having a data type of “name” in a data frame of data frames 320, and suppose that the data item accessible via data pin #1 is “Name11”. Then, if data pins 332 are all switched to refer to a new data frame with a name of“Name22”, the reference in data ontology 340 to data pin #1 would refer to the switched data item “Name22”. Many other examples are possible as well.

If data ontology 340 changes, references from data pins 332 into data ontology 340 can be changed as well. That is, each of data pins 332 can include at least two references: one or more references into data frames 320 for data item(s) and one or more references into data ontology 340 for node/edge data/logic. Then, changes in the structure, format, and/or layout of data frames 320 can be isolated by data pins 332 (and perhaps data frame selection logic 330) from data ontology 340 and vice versa.

In some embodiments, all pins switch together. Then, when data pins 332 indicate a data frame of data frames 320 has been switched, all references to data within data ontology 340 made using data pins 332 are updated simultaneously, or substantially simultaneously. If data ontology 340 changes, references from data pins 332 into data ontology 340 can be changed as well, thereby changing references to data made available by data pins 332. For example, if ontology 340 referred to data pin #1 to access a data type of “name” but changed to refer to a “first name” and a “last name”, the reference to data pin #1 may change; e.g., to refer to data pin #1 and #2 or some other data pin(s) of data pins 332.

In other embodiments, upon arrival of a new frame, some data pins 332 may not switch; e.g., a bank of data pins 332 referring to a first-received frame may not switch after the first data frame is received.

Ontological data from data ontology 340 can be arbitrarily transformed via transform 350 before providing data interactions 360. Because of the pin-linked ontology, fed by a fast-switched data set, in turn fed by preemptive data caching, pipeline 300 can use DIVE system 100 to provide quick interaction, analysis, and visualization of complex and multi-dimensional data.

### DIVE Object Parsing

Modern computational problems increasingly require formal ontological analysis. However, for some software hierarchies, formal ontologies do not exist. The generation of formal ontologies can be time consuming, difficult, and require expert attention. Ontologies are often implicitly defined in code by software engineers and so code, such as object hierarchies, can be parsed for conversion into a formal ontology.

For example, an object-parser can traverse object-oriented data structures within a provided assembly using code reflection. Using generalized rules to leverage the existing ontological structure, a formal ontology can be generated from the existing relationships of the data structures within the code. The ontology can be a static ontology defining an ontological structure or can be a dynamic ontology; that is, a dynamic ontology can include links between the ontological structure (of a static ontology) and object instances of the provided code assembly. The dynamic ontology can allow the underlying object instances to be modified through the context of the ontology without changes to the code assembly. In other examples, metadata tags can be added to the assembly to provide definitions for (generated) ontologies, and so provide a richer ontology definition.

DIVE system 100 can include a DIVE object parser, which can automatically generate datanodes and dataedges of a DIVE data structure from a software object hierarchy, such as a .NET object or assembly. Using reflection and expression trees, the DIVE object parser can consume object instances of the software object hierarchy and translates the object instances into propertied datanodes and dataedges of a DIVE data structure. For example, standard objects can be created by library-aware code. Then, those standard objects can be parsed by the DIVE object parser into a DIVE data structure, which can be injected into a DIVE pipeline as a data ontology.

The DIVE object parser can make software object hierarchies available for ontological data representation and subsequent use as DIVE plug-ins written without prior knowledge of DIVE. The DIVE object parser can include generic rules to translate between a software object hierarchy and a DIVE data structure. These generic rules can include:
Complex objects in the software object hierarchy, such as classes, can be translated into datanodes of a DIVE data structure.
Interfaces, virtual class, and abstract class objects in the software object hierarchy can be translated into datanodes of the DIVE data structure.
Built-in system objects, primitive fields, primitive properties, and methods with primitive return types in the software object hierarchy can be translated into properties on datanodes of the DIVE data structure.
Inheritance and member relationships objects in the software object hierarchy can be interpreted as object and property inheritance dataedges in the DIVE data structure, respectively; these dataedges can then connect the datanode hierarchy.

Additional rules beyond the generic rules can handle other program constructs:
The DIVE object parser can translate static members of the software object hierarchy into a single datanode in the DIVE data structure.
Multiple object instances with the same static member of the software object hierarchy can be translated to a single, static datanode instance in the DIVE data structure.
Public objects and members can always be parsed
Private members, static objects, and interfaces can be parsed based on parameters provided to the DIVE object parser and/or via other user-controllable data.
More, different, and/or other rules that these generic rules and additional rules for parsing software object hierarchies into DIVE data structures/ontologies are possible as well.

Throughout a parse, no data values are copied to datanodes or dataedges. Instead, dynamically created virtual properties link all datanode properties to their respective software object hierarchy members. So, any changes to runtime object instances are reflected in their corresponding representations in DIVE data structures. Similarly, any changes to datanode or dataedge properties in DIVE data structures propagate back to their software object instance counterparts.

Using this approach, the generic rules, and additional rules, the DIVE object parser can recursively produce an ontological representation of the entire software object hierarchy. With object parsing, users can import and use software object hierarchies within DIVE without special handling, so that software applications can be parsed and readily exploit DIVE capabilities. For example, assume L1 is a nonvisual code library that dynamically simulates moving bodies in space. A DIVE plug-in, acting as a thin wrapper, can automatically import library L1 and add runtime visualizations and interactive analyses. As the simulation progresses, the datanodes will automatically reflect the changing property values of the underlying software object instances. Through a DIVE interface, the user of the DIVE pipeline that imported L1 could change a body's mass. This change would propagate back to the runtime instance of L1 and appear in the visualization. Many other examples are possible as well.

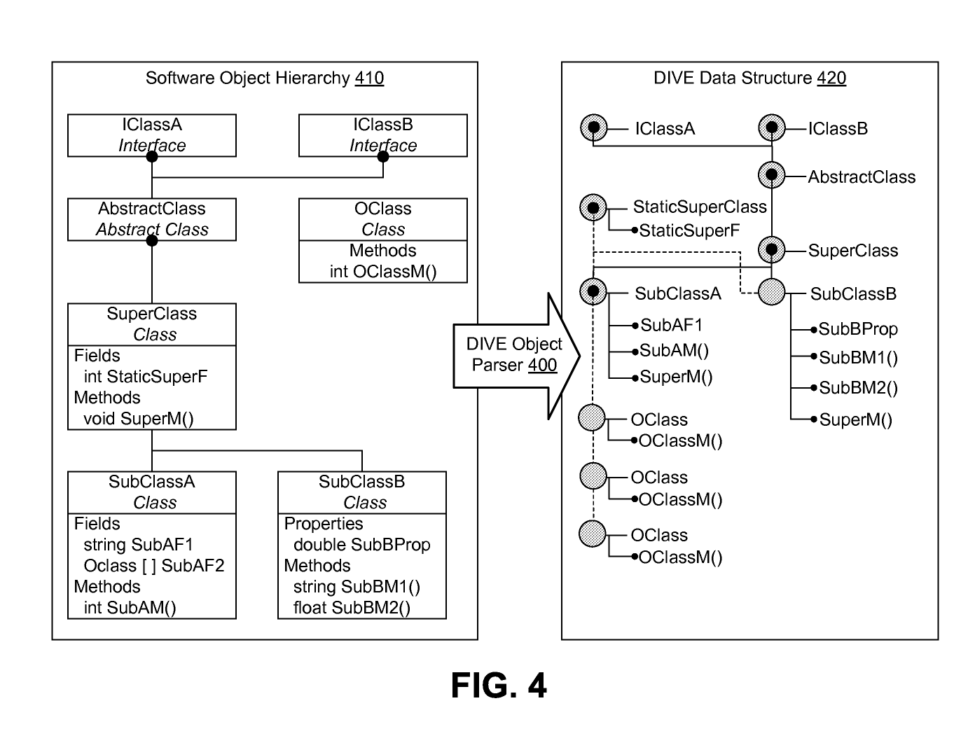

FIG. 4 shows an example where DIVE object parser 400 has converted software object hierarchy 410 to DIVE data structure 420, in accordance with an embodiment. In the example shown in FIG. 4, software object hierarchy 410 includes a .NET assembly with interfaces IClassA, IClassB and classes AbstractClass, OClass, SuperClass, SubClassA and SubClassB arranged using object inheritance, shown in FIG. 4 using solid lines between classes, into an object hierarchy. Some classes in software object hierarchy 410 include methods; e.g., class OClass has method OClassM( ) class SuperClass has method SuperM( ) class SubClassA has method SubAM( ), and class SubClassB has methods SubBM1( ) and SubBM2( ). Other classes have fields; e.g., class SuperClass has field StaticSuperF and class SubClassA has fields SubAF1 and SubAF2, while class SubClassB has property SubBProp.

Similarly, DIVE data structure 420 has datanodes for interfaces and classes IClassA, IClassB, Abstract Class, OClass, SuperClass, SubClassA and SubClassB, methods OClassM( ), SuperM( ),SubAM( ),SubBM1( ) and SubBM2( ) fields StaticSuperF, SubAF1, and SubAF2, and property SubBProp. Relationships between datanodes in DIVE data structure 420 are shown using both solid and dashed lines representing dataedges.

DIVE object parser 400 can parse software object hierarchy 410 for translation into a data ontology and/or DIVE data structure. In other examples, other software hierarchies than .NET assemblies can be input to DIVE object parser 400 for parsing. In the example shown in FIG. 4, DIVE object parser 400 can parse software object hierarchy 410 using the above-mentioned generic and additional rules to translate hierarchy 410 into DIVE data structure 420. DIVE data structure 420 can replicate the strongly typed objects and relationships indicated by the structure of software object hierarchy 410.

In the example shown in FIG. 4, DIVE data structure 420 represents a data ontology corresponding to software object hierarchy 410, with data nodes (shown in FIG. 4 as circles) corresponding to objects in software object hierarchy 410 and data edges (shown in FIG. 4 as lines) corresponding to relationships between objects in software object hierarchy 410. FIG. 4 shows some data edges in DIVE data structure 420 as solid lines, corresponding to object inheritance relationships in software object hierarchy 410. Other data edges in DIVE data structure 420 are shown in FIG. 4 as dashed lines, corresponding to property inheritance relationships in software object hierarchy 410.

Instance-specific data of software object hierarchy 410 are maintained on the subclass data nodes in DIVE data structure 420; that is, data for super classes is not stored with superclass data nodes. The original fields, properties, and methods of software object hierarchy 410 are accessible through the data nodes of DIVE data structure 420 by virtual properties.

In DIVE data structure 420, each instance of a class can be represented. For example, FIG. 4 shows DIVE data structure 420 with one instance of all classes except for class OClass. In this example, Class OClass has three instances, which are shown as three separate data nodes DIVE data structure 420.

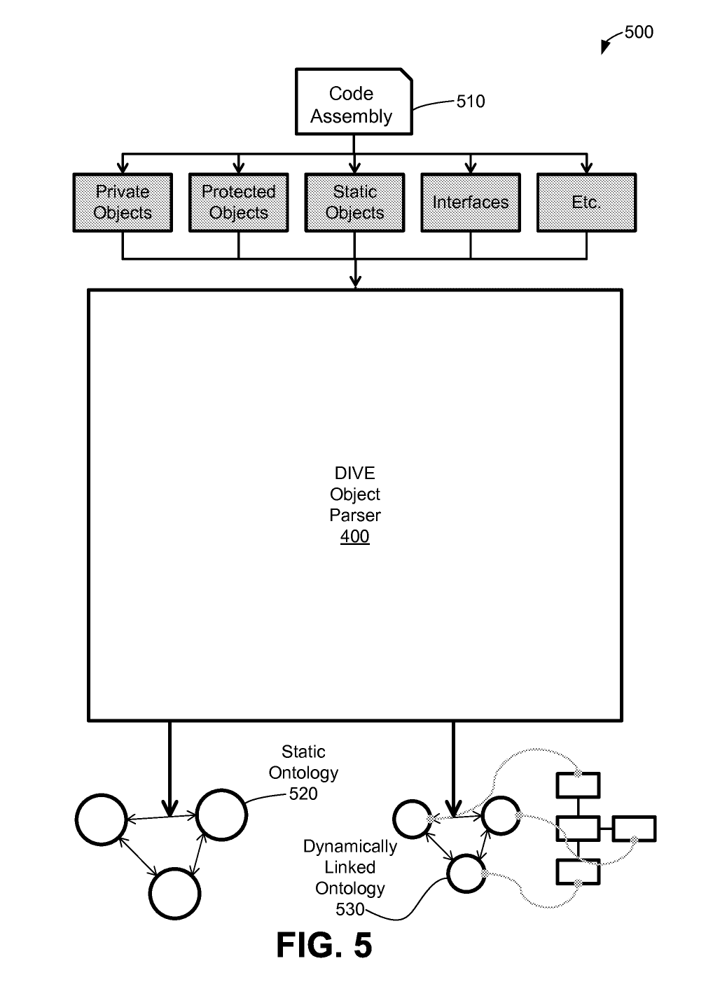

FIG. 5 shows scenario 500, where DIVE object parser 400 has translated code assembly 510 to ontologies 520, 530, in accordance with an example embodiment. Scenario 500 begins with code assembly 510 being provided to DIVE object parser 400. As indicated in FIG. 5, code assembly 510 can include private objects, protected objects, static objects, interfaces, and other software entities (“Etc.”). For example, code assembly 510 can be a software object hierarchy, such as software object hierarchy 410 discussed above in the context of FIG. 4.

In scenario 500, parameters to DIVE object parser 400 can specify which semantic components are to be parsed into one or more ontologies. For example, the parameters can reflect user intent regarding whether or not private members, static objects, interfaces, and other software entities of code assembly 510 are parsed.

DIVE object parser 400 can recursively traverse object hierarchies of code assembly 510 using code reflection and expression trees. Using generalized, pre-defined rules, such as the generic and additional rules discussed above in the context of FIG. 4, objects and other software entities can be parsed by DIVE object parser 400 into ontological components.

In scenario 500, DIVE object parser 400 outputs the ontological components in two formats: static ontology 520 corresponding to semantic components and relationships of code assembly 510 and dynamic ontology 520. Both static ontology 520 and dynamic ontology 530 can include an ontological definition that uses standardized ontology language. Dynamic ontology 530 can further include links into the object instance(s) of code assembly 510. For example, links between ontological components and object instances using delegate methods and lambda functions. FIG. 5 shows the ontological components of ontologies 520 and 530 using circles, object instances of code assembly 510 linked to ontology 530 using rectangles, and links between ontological components and object instances in ontology 530 using solid grey lines between the two.

### DIVE Scripting Techniques

DIVE supports the use of scripts to let users rapidly interact with the DIVE pipeline, plug-ins, data structures, and data. DIVE supports at least two basic types of scripting: plug-in scripting and μscripting (microscripting). DIVE can host components, including scripts, written in a number of computer languages. For example, in some embodiments, C# can be used as a scripting language.

Plug-in scripting is similar to existing analysis tools' scripting capabilities. Through the plug-in script interface, the user script can access the runtime environment, the DIVE system, and the specific plug-in. μscripting can provide direct programmatic control to experienced users and simple, intuitive controls to relatively-new users of DIVE.

μscripting is an extension of plug-in scripting in which DIVE writes most of the code. The user needs to write only the right-hand side of a lambda function. Here's a schematic of a lambda function F1( ):
F1(datanode dn)=>RHS;

The right-hand side RHS written by the user is inserted into the lambda function. The lambda function, including the user's right-hand-side code, is compiled at runtime. The client can provide any expression that evaluates to an appropriate return value. In general, plug-in scripting can be more powerful than μscripting, while μscripting can be simpler at first.

User scripts, such as plug-in scripts and μscripting-originated scripts, can be included into the DIVE system. For example, the user script can be incorporated into a larger, complete piece of code that can be compiled; e.g., during runtime using full optimization. Finally, through reflection, the compiled code is loaded back into memory as a part of the runtime environment. Although this approach requires time to compile each script, the small initial penalty is typically outweighed by the resulting optimized, compiled code. Both scripting types, particularly μscripting, can work on a per-datanode basis; optimized compilation helps create a fast, efficient user experience.

Table 1 below provides some μscripting examples.

TABLE 1

| | Return | | |
|---|---|---|---|
| Argument | Type | μscript | Comments |
| datanode dn | double | 3 | Basic constant |
| | | | numeric script |
| | | dn.X | Basic per-datanode script |
| | | Math.Abs(dn.X) | A μscript can call |
| | | | library functions |
| | int | dn.X > 0 ? 1 : −1 | μscript syntax can be powerful. |
| void | bool | { | μscripts can include |
| | | int hour = | complex, multi- |
| | | DateTime.Now.Hour; | statement functions. |
| | | return hour < 12; | |
| | | } | |
| datanode[ ] | Dynamic | from dn in dns | μscript for creating a |
| | Set | group dn by | histogram based on |
| | | Math.Round(dn.X, 2) | the datanode's “X” |
| | | into g | property. |
| | | select new | |
| | | { | |
| | | bin = g.Key, | |
| | | population = g.Count( ) | |
| | | }; | |
| | | from dn in dns | μscript for filtering |
| | | where dn.X > Math.Pi | datanodes on the |
| | | && dn.is_Superclass | basis of datanode |
| | | && dn.Func( ) = true | properties, methods |
| | | select dn; | (e.g., Func( )), and |
| | | | inherited type (e.g., |
| | | | is_Superclass). |
| | | from dn1 in dnSet1 | μscript for using |
| | | join dn2 in dnSet2 on | DIVE as OO |
| | | dn1.X equals dn2.X | database for joining |
| | | select new (X = dn1.X, Y | multiple potentially |
| | | = dn2.Y); | disparate datasets. |

### Data Streaming Using DIVE

DIVE system 100 can support data streaming using an interactive SQL approach and a pass-through SQL approach. In some embodiments, database languages other than SQL can be utilized by either approach. Interactive SQL can be used for the immediate analysis of large, nonlocal datasets via impromptu, user-defined dynamic database queries using SQL by taking user input to build an SQL query.

The SQL query can include one or more data queries, as well as one or more functions for analysis of data received via the data queries. DIVE system 100 can send the SQL query to the SQL database and parse the resulting dataset. Depending on the query's size and complexity, this approach can result in user-controlled SQL analysis through the GUI at interactive rates. DIVE system 100 can facilitate interactive SQL by use of events generated at runtime; for example, DIVE events can be generated in response to mouse clicks or slider bar movements. Upon receiving these DIVE events, a DIVE component can construct the appropriate SQL query.

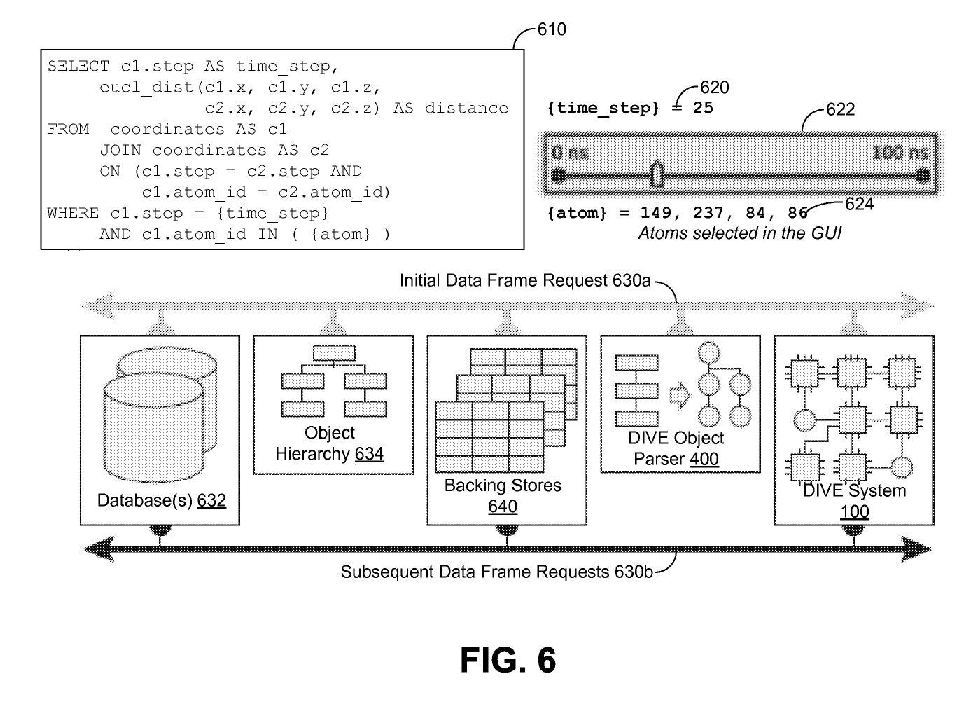

FIG. 6 shows examples of interactive SQL streaming and pass-through SQL streaming, in accordance with an example embodiment. With respect to interactive SQL, FIG. 6 shows an example SQL template 610 with tags for “time_step” and “atom”. During interactive SQL streaming, the tags in SQL template 610 can be replaced with input from GUI elements, such as slider bar 620, 622 and atoms 624, where atoms 624 can be selected using GUI elements not shown in FIG. 6.

An SQL query can use SQL template 610 to obtain and analyze data. In the example shown in FIG. 6, the SQL query can obtain “coordinates” data for item “c1” and join data for item “c2” to become part of the “coordinates” data. Then, the time_step tagged data can be set to a “step” value of c1 and the atom tagged data can be set to an “atom_id” value of c1. Subsequently, when the step value of c1 equals a step value for c2 and the atom_id value of c1 equals an atom_id of c2, then the obtained data for c1 and c2 can be analyzed using a eucl_dist( ) function operating on “x”, “y”, and “z” values from both c1 and c2 to determine a resulting “distance” value.

The pass-through SQL approach can be used for interactive analysis of datasets larger than the client's local memory; e.g., pass-through SQL can be used for streaming complex object models across a preset dimension. Pass-through SQL accelerates the translation of SQL data into OO structures by shifting the location of values from the objects themselves to an in-memory data structure called a backing store.

A backing store can include a collection of one or more tables of instance data, where each table can contain one or more instance values for a single object type. Internally, object fields and properties have pointers to locations in backing-store tables instead of local, fixed values. A backing-store collection then includes all the tables for the object instances occurring at the same point, or frame, in the streaming dimension.

Once a backing store has been created by DIVE system 100, copies of the backing-store structure can be generated with a unique identifier for each new frame. DIVE system 100 then inserts instance values for new frames into the corresponding backing-store copy. This reduces the loading of instance data to a table-to-table copy, bypassing the parsing normally required to insert data into an OO structure. The use of backing stores also removes the overhead of allocating and de-allocating expensive objects by reusing the same object structures for each frame in the streaming dimension.

Pass-through SQL enables streaming through a buffered backing-store collection of backing stores representing frames over the streaming dimension. A backing-store collection is initially populated client-side for frames on either side of the frame of interest, where buffer regions are defined for each end of the backing-store collection. Frames whose data are stored in the backing-store collection are immediately accessible to the client. When the buffer regions' thresholds are traversed during streaming, a background thread is spawned to load a new set of backing stores around the current frame; e.g., by the pre-loader. If the client requests a frame outside the loaded set, a new backing-store collection can be loaded around the requested frame. Loaded backing stores no longer in the streaming collection can be deleted from memory to conserve the client's memory.

FIG. 6 shows an example use of pass-through SQL streaming. On initial data frame request 630a, DIVE system 100 can construct a datanode hierarchy; e.g., an ontology from object hierarchy 634 using DIVE object parser 400. Then, DIVE system 100 can generate backing stores 640 corresponding to the initial data frame that includes data retrieved from database(s) 632. Backing stores 640 can be arranged as one or more backing store collections.

On each subsequent data frame request 630b, DIVE system 100 can buffer data retrieved from database(s) 632 into backing stores 640 directly. In some embodiments, DIVE system 100 can use multiple threads to buffer data into backing stores 640. DIVE system 100 can use pass-through SQL streaming to propagate large amounts of data through a DIVE pipeline using database(s) 632, object hierarchy 634, and backing stores 640 at interactive speeds; i.e., by bypassing object-oriented parsing.

### A DIVE Case Study: The Dynameomics Project

In a case study, DIVE is used by the Dynameomics project to provide molecular dynamics simulations for studying protein structure and dynamics. The Dynameomics project involves characterization of the dynamic behaviors and folding pathways of topological classes of all known protein structures.

An interesting facet of protein biology is that structure equals function; that is, what a protein does and how it does it is intrinsically tied to its 3D structure. During a molecular dynamics simulation, scientists simulate interatomic forces to predict motion among atoms of a molecule, such as a protein, and its environment to better understand the 3D structure of the molecule.

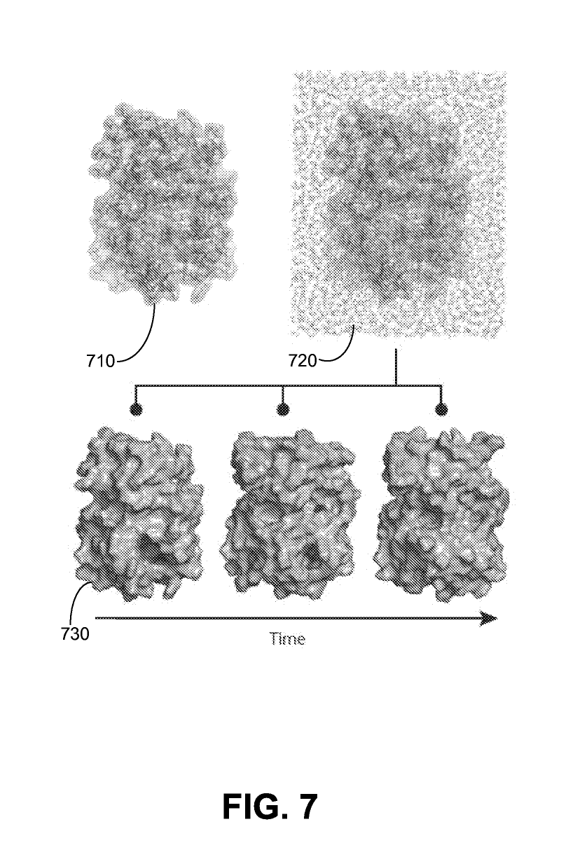

FIG. 7 shows an example protein simulated using molecular dynamics, in accordance with an embodiment. Image 710 is an all-atom depiction of the example protein with a transparent surface. In most cases, the environment for a protein molecule is water molecules, although scientists can alter this to investigate different phenomena. For example, image 720 shows the protein depicted in image 710 solvated and shown in a water box.

The physical simulation is calculated using Newtonian physics; at specified time intervals, the simulation state is saved. This produces a trajectory or a series of structural snapshots reflecting the protein's natural behavior in an aqueous environment. Image 730 shows three structures selected from a trajectory containing more than 51,000 frames.

Molecular dynamics is useful for three primary reasons. First, like many in silico techniques, it allows virtual experimentation; scientists can simulate protein structures and interactions without the cost or risk of laboratory experiments. Second, modern computing techniques allow molecular dynamics simulations to run in parallel, enabling virtual high-throughput experimentation. Third, molecular dynamics simulation is the only protein analysis method that produces sequential time-series structures at both high spatial and high temporal resolution. These high-resolution trajectories can reveal how proteins move, a critical aspect of their functionality.

However, molecular dynamics simulations can produce datasets considerably larger than what most structural-biology tools can handle. So far, the Dynameomics project has generated hundreds of terabytes of data consisting of thousands of simulations and millions of structures, as well as their associated analyses, stored in a distributed SQL data warehouse. The data warehouse can hold at least four orders of magnitude more protein structures than the Protein Data Bank, which is the World's primary repository for experimentally characterized protein structures.

In particular, the Dynameomics project contains much more simulation data than many domain-specific tools are engineered to handle. One of the first Dynameomics tools built on the DIVE platform was the Protein Dashboard. The Protein Dashboard which provides interactive 2D and 3D visualizations of the Dynameomics dataset. These visualizations include interactive explorations of bulk data, molecular visualization tools, and integration with external tools such as Chimera.

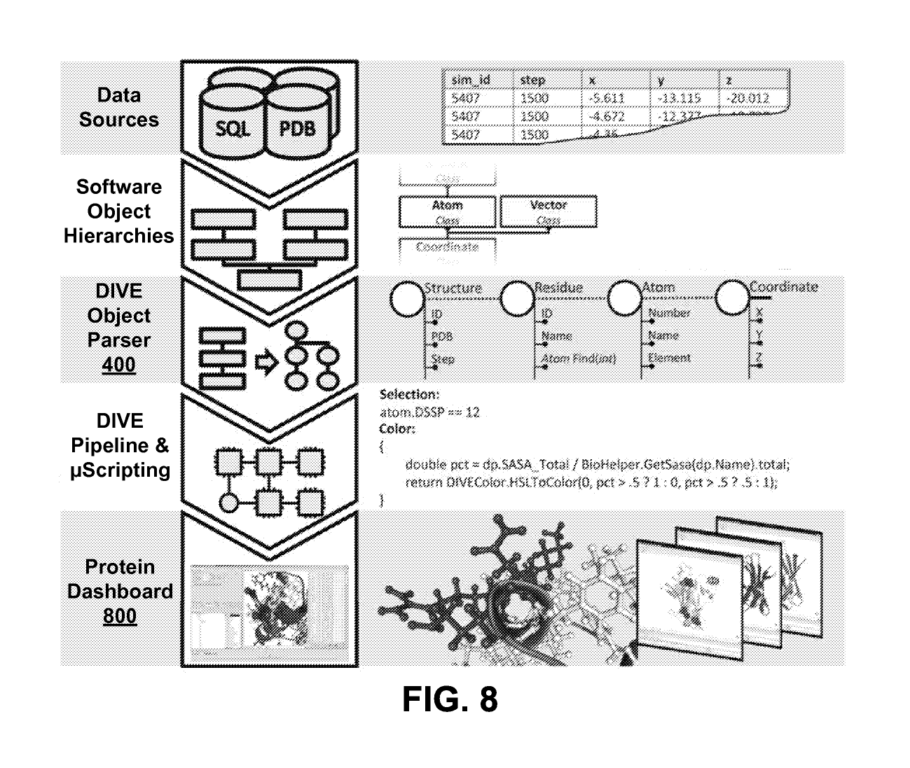

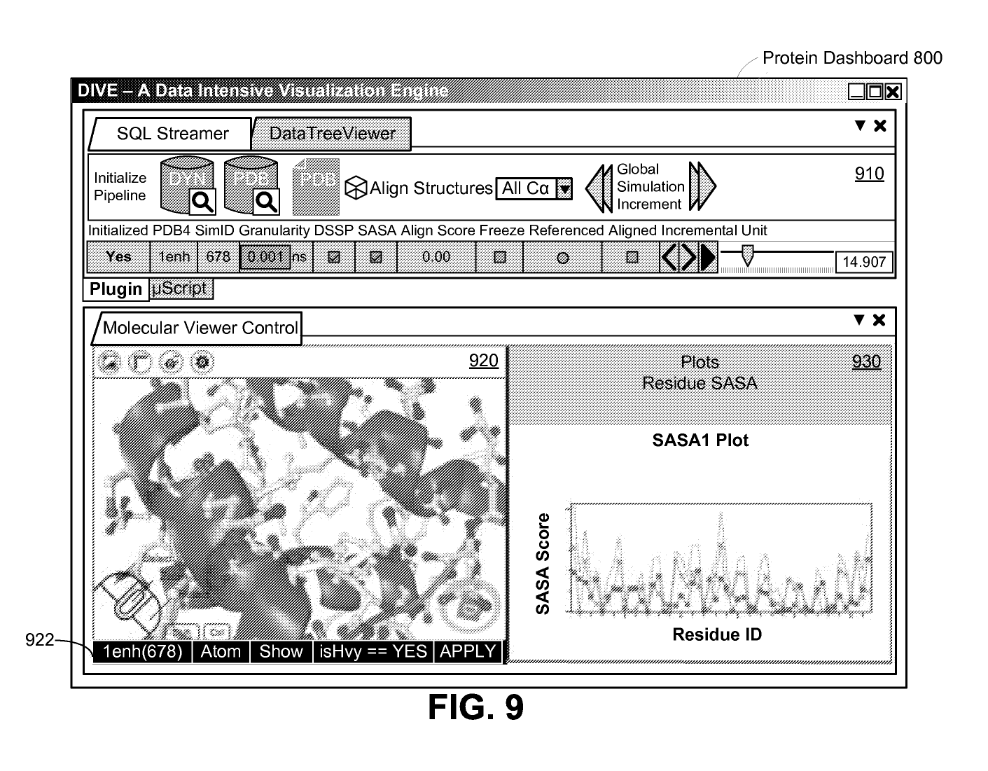

FIG. 8 shows an example data flow using DIVE system 100 for the Dynameomics project, in accordance with an example embodiment. Using DIVE object parser 400, DIVE system 100 can integrate and use structures developed using a Dynameomics API (discussed after FIG. 9) without changing DIVE's API. DIVE object parser 400 can then create strongly typed objects, including Structure, Residue, Atom, and Contact as datanodes, with each datanode containing properties defined by the Dynameomics API. Semantic and syntactic relationships specified in the Dynameomics API can be translated into dataedges by DIVE object parser 400. The Dynameomics-related datanodes and dataedges generated by DIVE object parser 400 are available to the DIVE pipeline, indistinguishable from any other datanodes or dataedges.

The top of FIG. 8 shows data sources for the data flow, including Dynameomics data stored a data warehouse in SQL format and the Protein Data Bank (PDB). Associated with the data sources are software object hierarchies for representing the data in software. In the example of the case study, the software object hierarchies are part of .NET assemblies. The software object hierarchies in the case study can be parsed using the DIVE object parser 400, as indicated by the middle portion of FIG. 8. DIVE object parser 400 can generate datanodes and dataedges corresponding to the software object hierarchies.

The generated datanodes and dataedges, along with DIVE plug-ins, μscripts, plug-in scripts, DIVE tools, and/or other software entities, can be used together as a DIVE pipeline, as indicated a lower portion of FIG. 8. The bottom portion of FIG. 8 indicates that a user can interact with the DIVE pipeline via Protein Dashboard 800. Protein Dashboard 800 can allow access to multiple interactive simulations simultaneously.

FIG. 9 shows an example view of Protein Dashboard 800, in accordance with an embodiment. The view of Protein Dashboard 800 is an example view generated by a graphical user interface for DIVE system 100. An upper portion of Protein Dashboard 800 includes pre-loader interface 910 to allow interaction with a DIVE pre-loader; e.g., pre-loader 310. Pre-loader interface 910 provides user controls for loading and interacting with protein structures and molecular-dynamics trajectories.

At lower left of FIG. 9, interactive rendering interface 920 shows an interactive 3D rendering of a protein molecule; using a cartoon representation of a backbone of the protein molecule, and a ball-and-stick representation of a subset of atoms in the protein molecule. The subset of atoms can be selected via interactive SQL interface 922, which includes a molecule selector to select a “1enh(678)” molecule, an indicator to show “Atom[s]” of the molecule, and script interface showing selection of data with the property “isHvy==YES”, and an apply button. Once the apply button is selected, a selection made using interactive SQL interface 922 to Protein Dashboard 800 can be rendered and displayed using interactive rendering interface 920.

Chart region 930 shows one of many possible linked interactive charts for a “SASA1 Plot” related to “Residue SASA”. The interactive charts can be generated using data streamed from the data sources mentioned in the context of FIG. 8; e.g., the Dynameomics data warehouse. In some embodiments and examples, Protein Dashboard 800 can provide more, fewer, and/or different windows, tabs, interfaces, buttons, and/or GUI elements than shown in FIGS. 8 and 9.

A tool implemented independently of DIVE and the Protein Dashboard is the Dynameomics API. The API can be used to establish an object hierarchy, provide high-throughput streaming of simulations from the Dynameomics data warehouse. The Dynameomics API includes domain-specific semantics and data structures and provides multiple domain-specific analyses. In some embodiments, the Dynameomics API can be user interface agnostic; then, the Dynameomics API can provide data handling and streaming support independently of how the user views and otherwise interacts with the data; e.g., using the Protein Dashboard. In some embodiments, the API can be written in a particular computer language; e.g., C#.

With the Dynameomics data and semantics available to the DIVE pipeline, a visual analytics approach can be applied to the Dynameomics data. Protein Dashboard 800 can be used to interact with and visualize the data. However, because the data flows through the Dynameomics API, wrapped by DIVE datanodes and dataedges, multiple protein structures from different sources can be loaded, including structures from the Protein Data Bank. Once loaded, the protein structures can be aligned and analyzed in different ways.

Furthermore, because Protein Dashboard 800 has access to additional data from the Dynameomics API via DIVE system 100, the utility of Protein Dashboard 800 increases. For instance, scientists can find utility in coloring protein structures on the basis of biophysical properties; e.g., solvent-accessible surface area, deviation from a baseline structure. By streaming the data through the pipeline, these biophysical properties can be observed as they change over time. In some instances, some or all of the biophysical properties can be accessed through the data's inheritance hierarchy.

Applications built on DIVE system 100 have been used to accelerate biophysical analysis of Dynameomics and other data related to two specific proteins. The first protein is the transcription factor p53, mutations in which are implicated in cancer. The second protein is human Cu—Zn superoxide dismutase 1 (SOD1), mutations in which are associated with amyotrophic lateral sclerosis.

The Y220C mutation of the p53 DNA binding domain is responsible for destabilizing the core, leading to about 75,000 new cancer cases annually according to Boeckler et al. The DIVE framework can analyze the structural and functional effects of the Y220C mutation using a DIVE module called ContactWalker. The ContactWalker module can identify amino acids' interatomic contacts disrupted significantly as a result of mutation. The contact pathways between disrupted residues can be identified identified using DIVE's underlying graph-based data representation.

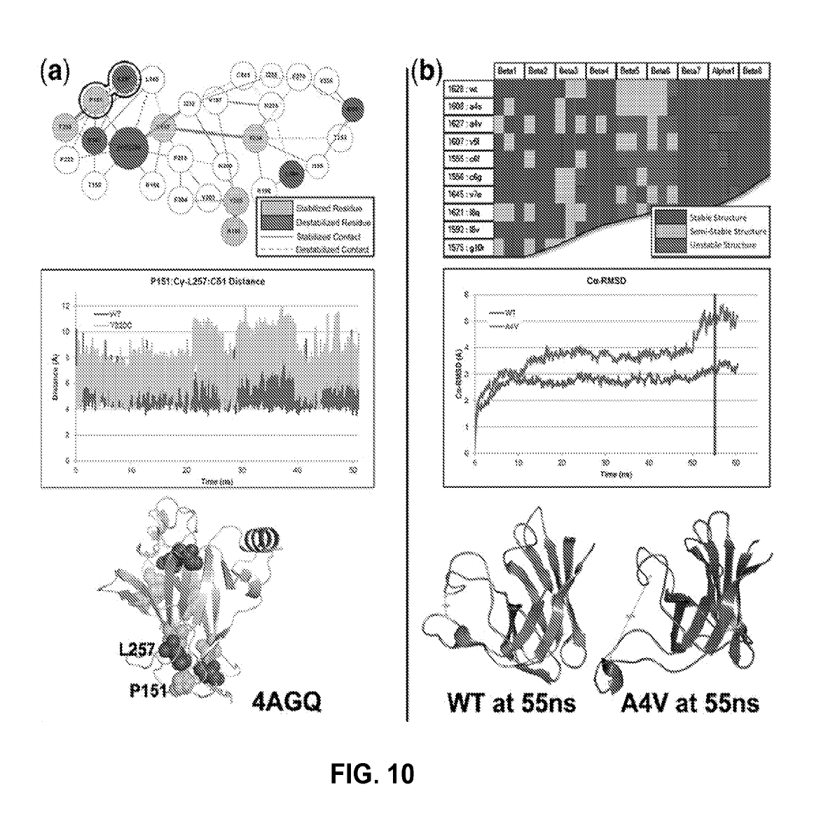

FIGS. 10A and 10B show visualizations related to the respective p53 and SOD1 proteins provided by DIVE system 100, in accordance with an embodiment. FIG. 10A shows the most disrupted contacts in the vicinity of the Y220C mutation. Specific residues, contacts and simulations were identified for more focused analysis. Interesting interatomic contact data were isolated. Then, specific molecular dynamics time points and structures were selected for further investigation. For example, FIG. 10A shows contact data mapped onto a structure containing a stabilizing ligand, which docks closely to many of the disrupted residues, suggesting a correlation between the mutation-associated effects and the observed stabilizing effects of the ligand.

In particular, FIG. 10A shows visualizations related to the p53 protein. In the top panel of FIG. 10A, a ContactWalker summary of contact differences between wild-type and Y220C simulations is shown. The highlighted residues have contacts with >50% occupancy change. In the middle panel of FIG. 10A, distances between P151 and L257 are outlined in black. In the bottom panel of FIG. 10A, a visualization of the p53 protein is shown with ligand (stick figure at bottom) (Protein Data Bank code 4AGQ) in proximity to disrupted residues shown in black.

In another example, DIVE has been used in about 400 simulations of 106 disease-associated mutants of SOD1. Through extensive studies of A4V mutant SOD1, Schmidlin et al. previously noted the instability of two β-strands in the SOD1 Greek key β-barrel structure. That analysis took several years to complete and such manual interrogation of simulations does not scale to allow us to search for general features linked to disease across hundreds of simulations.

DIVE system 100 was used to further explore the formation and persistence of the contacts and packing interactions in this region across multiple simulations of mutant proteins. DIVE system 100 facilitates isolation of specific contacts, rapid plotting of selected data, and easy visualization of the relevant structures and geographic locations of specific mutations, while providing intuitive navigation from one view to another.

The top panel of FIG. 10B maps secondary structure for different variants as an example of DIVE's charting tools. This chart can be quickly generated and contains results for 400 SOD1 mutant simulations. The chart is customizable and links to the protein structure property data (in this case the change in the structure over time) with a single mouse click. These data are in turn linked to protein structure modules, allowing interactive visualization of more than 60,000 structures from each of the 400 simulations, all streamed from the Dynameomics data warehouse. DIVE system 100 can simplify the transition between high-level protein views and atomic level details, facilitating rapid analysis of large amounts of data. DIVE system 100 can also show the context of the detailed results on other levels, such as worldwide disease incidence.

In particular, FIG. 10B shows visualizations related to analysis of the SOD1 protein. In the top portion of FIG. 10B, aggregated secondary structural data from mutant simulations is shown. The middle portion of FIG. 10B is a plot of the Ca root-mean-squared (RMS) distances of the wild-type and A4V mutant simulations. In the bottom portion of FIG. 10B, a visualization of molecular dynamics structures is shown.

### Additional Example DIVE Pipelines

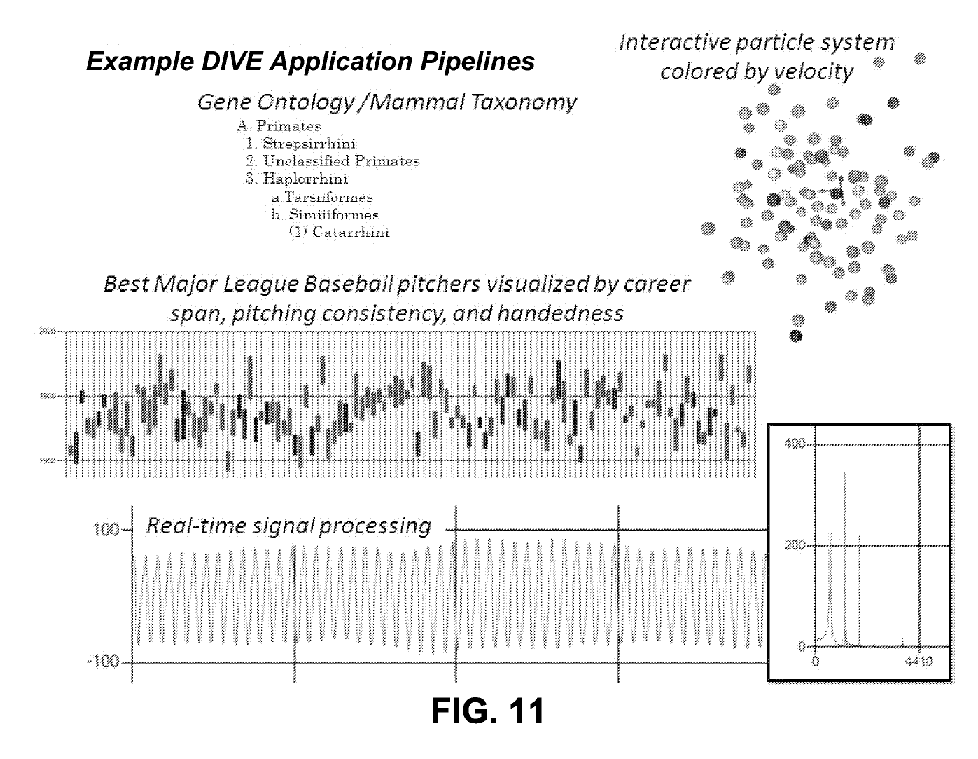

Example DIVE application pipelines are shown in FIG. 11, in accordance with an embodiment. FIG. 11 shows, at upper left and center, an example Gene Ontology/Mammal Taxonomy DIVE pipeline. This example shows a taxonomy of mammals built up from data from a static (non-streaming) Gene Ontology database for handling the concept of animal inheritance. In an example interaction with the Gene Ontology/Mammal Taxonomy DIVE pipeline, a user could ask for all mammals descended from tree shrews or all feline mammals. The DIVE Pipeline can be then be used to provide streaming data, such as camera feeds from mammalian research sources, as well as access to the Gene Ontology database. Then, if the user requests to “show all the streaming video data watching animals of subgenus platyrrhini” (e.g., New World monkeys), the Gene Ontology/Mammal Taxonomy DIVE pipeline can use and provide both the streaming data and the ontology together Once both data sources are available, a DIVE plug-in acting as a software agent can be added to the pipeline; e.g., to inform the user when an animal is in a frame of the streaming video data.

FIG. 11 shows, at upper-right, an Animated Particle System DIVE pipeline. The DIVE pipeline renders the images based on an ontological representation of particles whose data is available in a data stream. Use of a particle ontology provides ready access for an application to query properties of various particles shown by the Animated Particle System DIVE pipeline. Another portion of the pipeline performs the simulation of particle interaction and, independently, the simulation is visualized. In some embodiments, the Animated Particle System DIVE pipeline can show how DIVE pipelines extend an existing library by added visualization and interaction components to a simple particle system.

FIG. 11 shows, at center, an example baseball statistics DIVE pipeline. The incoming data source is stored using flat files. The baseball statistics DIVE pipeline illustrates that, even in a single-data-frame scenario, the remainder of the pipeline can remain the same. In other implementations, the flat files could be replaced by a tabular system where statistics are streamed; e.g., streamed in real-time, on a per-year basis, on a per-player basis, or by some other basis.

The lower portion of FIG. 11 shows an example real-time signal processing DIVE pipeline, processing data from a microphone. In this pipeline, the ontological data-graph is hooked back to a byte buffer, through which is streaming raw audio data. This pipeline illustrates the generality of pipeline processing of an ontological graph connected to some kind of dynamic data source. In other embodiments, multiple sensors could be connected to a related DIVE pipeline, where data from the sensors is represented via some ontology; e.g., an ontology for medical sensors. Then, a user could request the pipeline to “alert when any sensor monitoring the cardio-pulmonary system downstream of the injection site registers a value outside of the specified safety thresholds.” In this pipeline, the cardio-pulmonary specification would be derived from the overall ontology of sensors.

In another example, the user could request a continuous data stream based on location-related sensor data; e.g., request data from “all deep-ocean current sensors within 100 miles of the up-to-the-minute GPS position of any Navy ship over 1000 tons and under the eventual command of Admiral Jones.” In this case, the ontology graph would have to cover naval vessels, command hierarchies, and ocean sensor data. In this case, the subset of the ontology can change in real time as the ships moves (and perhaps as command changes). Then, queries can be made against the larger ontological graph of naval vessels and undersea sensors using live data streams as part of the query to provide the requested continuous data stream. Many other example DIVE pipelines and uses of DIVE system 100 are possible as well.

### Example Computing Network

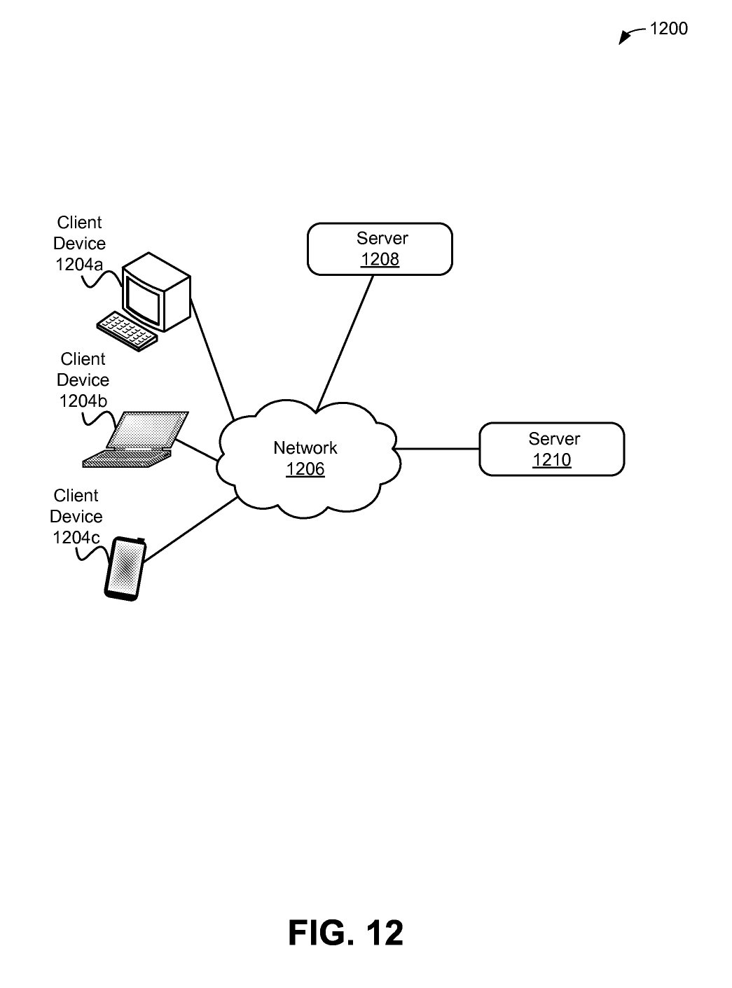

FIG. 12 is a block diagram of example computing network 1200 in accordance with an example embodiment. In FIG. 12, servers 1208 and 1210 are configured to communicate, via a network 1206, with client devices 1204a, 1204b, and 1204c. As shown in FIG. 12, client devices can include a personal computer 1204a, a laptop computer 1204b, and a smart-phone 1204c. More generally, client devices 1204a-1204c (or any additional client devices) can be any sort of computing device, such as a workstation, network terminal, desktop computer, laptop computer, wireless communication device (e.g., a cell phone or smart phone), and so on.

The network 1206 can correspond to a local area network, a wide area network, a corporate intranet, the public Internet, combinations thereof, or any other type of network(s) configured to provide communication between networked computing devices. In some embodiments, part or all of the communication between networked computing devices can be secured.

Servers 1208 and 1210 can share content and/or provide content to client devices 1204a-1204c. As shown in FIG. 12, servers 1208 and 1210 are not physically at the same location. Alternatively, servers 1208 and 1210 can be co-located, and/or can be accessible via a network separate from network 1206. Although FIG. 12 shows three client devices and two servers, network 1206 can service more or fewer than three client devices and/or more or fewer than two servers. In some embodiments, servers 1208, 1210 can perform some or all of the herein-described methods; e.g., method 1400.

### Example Computing Device

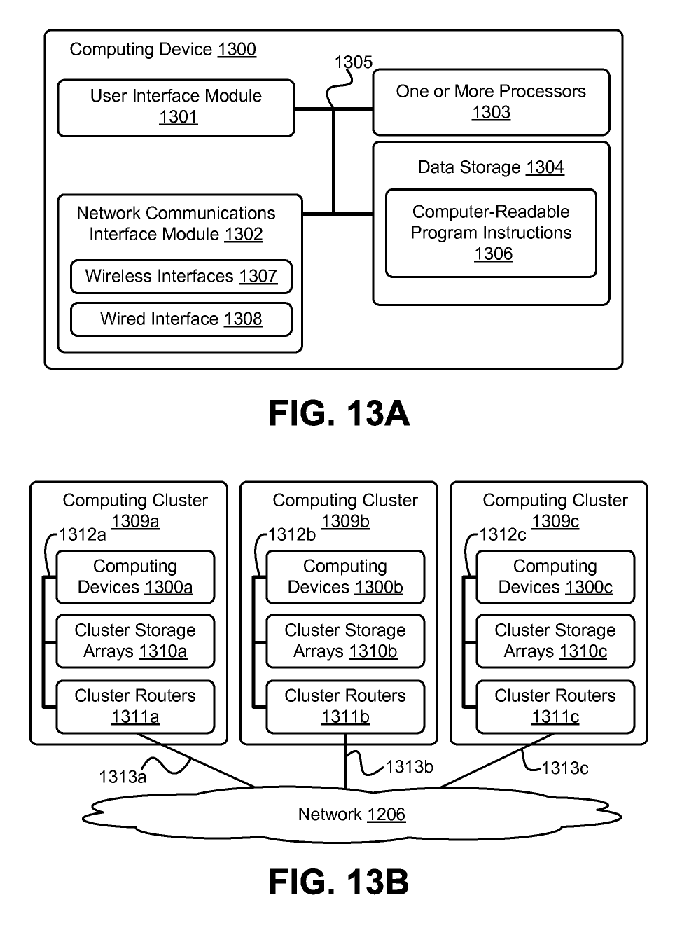

FIG. 13A is a block diagram of an example computing device 1300 including user interface module 1301, network communication interface module 1302, one or more processors 1303, and data storage 1304, in accordance with an embodiment.

In particular, computing device 1300 shown in FIG. 13A can be configured to perform one or more functions of DIVE system 100, data sources 110, pre-loader 310, data frames 320, data frame selection logic 330, data pins 332, data ontology 340, transform 350, data interactions 360, DIVE object parser 400, one or more DIVE pipelines, Protein Dashboard 800, client devices 1204a-1204c, network 1206, and/or servers 1208, 1210 and/or one or more functions of method 1400. Computing device 1300 may include a user interface module 1301, a network communication interface module 1302, one or more processors 1303, and data storage 1304, all of which may be linked together via a system bus, network, or other connection mechanism 1305.

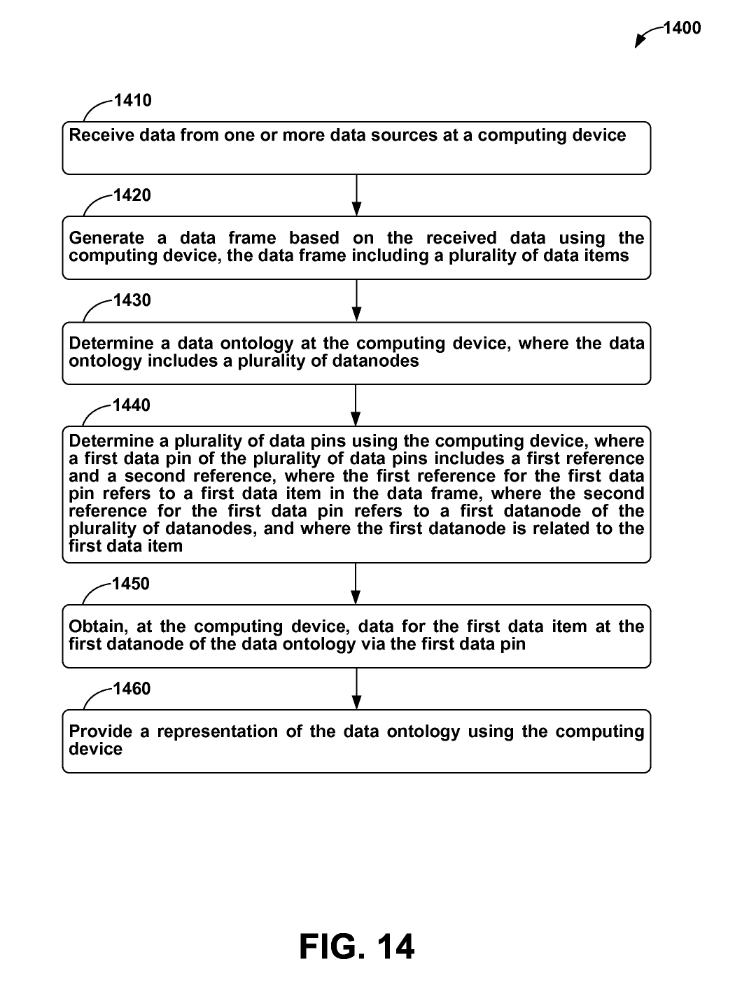

Computing device 1300 can be a desktop computer, laptop or notebook computer, personal data assistant (PDA), mobile phone, embedded processor, touch-enabled device, or any similar device that is equipped with at least one processing unit capable of executing machine-language instructions that implement at least part of the herein-described techniques and methods, including but not limited to method 1400 described with respect to FIG. 14.

User interface 1301 can receive input and/or provide output, perhaps to a user. User interface 1301 can be configured to send and/or receive data to and/or from user input from input device(s), such as a keyboard, a keypad, a touch screen, a computer mouse, a track ball, a joystick, and/or other similar devices configured to receive input from a user of the computing device 1300.

User interface 1301 can be configured to provide output to output display devices, such as one or more cathode ray tubes (CRTs), liquid crystal displays (LCDs), light emitting diodes (LEDs), displays using digital light processing (DLP) technology, printers, light bulbs, and/or other similar devices capable of displaying graphical, textual, and/or numerical information to a user of computing device 1300. User interface module 1301 can also be configured to generate audible output(s), such as a speaker, speaker jack, audio output port, audio output device, earphones, and/or other similar devices configured to convey sound and/or audible information to a user of computing device 1300.

Network communication interface module 1302 can be configured to send and receive data over wireless interface 1307 and/or wired interface 1308 via a network, such as network 1206. Wireless interface 1307 if present, can utilize an air interface, such as a Bluetooth®, Wi-Fi®, ZigBee®, and/or WiMAX™ interface to a data network, such as a wide area network (WAN), a local area network (LAN), one or more public data networks (e.g., the Internet), one or more private data networks, or any combination of public and private data networks. Wired interface(s) 1308, if present, can comprise a wire, cable, fiber-optic link and/or similar physical connection(s) to a data network, such as a WAN, LAN, one or more public data networks, one or more private data networks, or any combination of such networks.

In some embodiments, network communication interface module 1302 can be configured to provide reliable, secured, and/or authenticated communications. For each communication described herein, information for ensuring reliable communications (i.e., guaranteed message delivery) can be provided, perhaps as part of a message header and/or footer (e.g., packet/message sequencing information, encapsulation header(s) and/or footer(s), size/time information, and transmission verification information such as CRC and/or parity check values). Communications can be made secure (e.g., be encoded or encrypted) and/or decrypted/decoded using one or more cryptographic protocols and/or algorithms, such as, but not limited to, DES, AES, RSA, Diffie-Hellman, and/or DSA. Other cryptographic protocols and/or algorithms can be used as well as or in addition to those listed herein to secure (and then decrypt/decode) communications.

Processor(s) 1303 can include one or more central processing units, computer processors, mobile processors, digital signal processors (DSPs), graphics processing units (GPUs), microprocessors, computer chips, and/or other processing units configured to execute machine-language instructions and process data. Processor(s) 1303 can be configured to execute computer-readable program instructions 1306 that are contained in data storage 1304 and/or other instructions as described herein.

Data storage 1304 can include one or more physical and/or non-transitory storage devices, such as read-only memory (ROM), random access memory (RAM), removable-disk-drive memory, hard-disk memory, magnetic-tape memory, flash memory, and/or other storage devices. Data storage 1304 can include one or more physical and/or non-transitory storage devices with at least enough combined storage capacity to contain computer-readable program instructions 1306 and any associated/related data and data structures, including but not limited to, data frames, data pins, ontologies, DIVE data structures, software objects, software object hierarchies, code assemblies, data interactions, scripts (including μscripts).

Computer-readable program instructions 1306 and any data structures contained in data storage 1306 include computer-readable program instructions executable by processor(s) 1303 and any storage required, respectively, to perform at least part of herein-described methods, including, but not limited to method 1400 described with respect to FIG. 14.

FIG. 13B depicts a network 1206 of computing clusters 1009a, 1009b, 1009c arranged as a cloud-based server system in accordance with an example embodiment. Data and/or software for DIVE system 100 can be stored on one or more cloud-based devices that store program logic and/or data of cloud-based applications and/or services. In some embodiments, DIVE system 100 can be a single computing device residing in a single computing center. In other embodiments, DIVE system 100 can include multiple computing devices in a single computing center, or even multiple computing devices located in multiple computing centers located in diverse geographic locations.

In some embodiments, data and/or software for DIVE system 100 can be encoded as computer readable information stored in tangible computer readable media (or computer readable storage media) and accessible by client devices 1204a, 1204b, and 1204c, and/or other computing devices. In some embodiments, data and/or software for DIVE system 100 can be stored on a single disk drive or other tangible storage media, or can be implemented on multiple disk drives or other tangible storage media located at one or more diverse geographic locations.

FIG. 13B depicts a cloud-based server system in accordance with an example embodiment. In FIG. 13B, the functions of DIVE system 100 can be distributed among three computing clusters 1309a, 1309b, and 1308c. Computing cluster 1309a can include one or more computing devices 1300a, cluster storage arrays 1310a, and cluster routers 1311a connected by a local cluster network 1312a. Similarly, computing cluster 1309b can include one or more computing devices 1300b, cluster storage arrays 1310b, and cluster routers 1311b connected by a local cluster network 1312b. Likewise, computing cluster 1309c can include one or more computing devices 1300c, cluster storage arrays 1310c, and cluster routers 1311c connected by a local cluster network 1312c.

In some embodiments, each of the computing clusters 1309a, 1309b, and 1309c can have an equal number of computing devices, an equal number of cluster storage arrays, and an equal number of cluster routers. In other embodiments, however, each computing cluster can have different numbers of computing devices, different numbers of cluster storage arrays, and different numbers of cluster routers. The number of computing devices, cluster storage arrays, and cluster routers in each computing cluster can depend on the computing task or tasks assigned to each computing cluster.

In computing cluster 1309a, for example, computing devices 1300a can be configured to perform various computing tasks of DIVE system 100. In one embodiment, the various functionalities of DIVE system 100 can be distributed among one or more of computing devices 1300a, 1300b, and 1300c. Computing devices 1300b and 1300c in computing clusters 1309b and 1309c can be configured similarly to computing devices 1300a in computing cluster 1309a. On the other hand, in some embodiments, computing devices 1300a, 1300b, and 1300c can be configured to perform different functions.

In some embodiments, computing tasks and stored data associated with DIVE system 100 can be distributed across computing devices 1300a, 1300b, and 1300c based at least in part on the processing requirements of DIVE system 100, the processing capabilities of computing devices 1300a, 1300b, and 1300c, the latency of the network links between the computing devices in each computing cluster and between the computing clusters themselves, and/or other factors that can contribute to the cost, speed, fault-tolerance, resiliency, efficiency, and/or other design goals of the overall system architecture.

The cluster storage arrays 1310a, 1310b, and 1310c of the computing clusters 1309a, 1309b, and 1309c can be data storage arrays that include disk array controllers configured to manage read and write access to groups of hard disk drives. The disk array controllers, alone or in conjunction with their respective computing devices, can also be configured to manage backup or redundant copies of the data stored in the cluster storage arrays to protect against disk drive or other cluster storage array failures and/or network failures that prevent one or more computing devices from accessing one or more cluster storage arrays.

Similar to the manner in which the functions of DIVE system 100 can be distributed across computing devices 1300a, 1300b, and 1300c of computing clusters 1309a, 1309b, and 1309c, various active portions and/or backup portions of these components can be distributed across cluster storage arrays 1310a, 1310b, and 1310c. For example, some cluster storage arrays can be configured to store one portion of the data and/or software of DIVE system 100, while other cluster storage arrays can store a separate portion of the data and/or software of DIVE system 100. Additionally, some cluster storage arrays can be configured to store backup versions of data stored in other cluster storage arrays.

The cluster routers 1311a, 1311b, and 1311c in computing clusters 1309a, 1309b, and 1309c can include networking equipment configured to provide internal and external communications for the computing clusters. For example, the cluster routers 1311a in computing cluster 1309a can include one or more internet switching and routing devices configured to provide (i) local area network communications between the computing devices 1300a and the cluster storage arrays 1301a via the local cluster network 1312a, and (ii) wide area network communications between the computing cluster 1309a and the computing clusters 1309b and 1309c via the wide area network connection 1313a to network 1206. Cluster routers 1311b and 1311c can include network equipment similar to the cluster routers 1311a, and cluster routers 1311b and 1311c can perform similar networking functions for computing clusters 1309b and 1309b that cluster routers 1311a perform for computing cluster 1309a.

In some embodiments, the configuration of the cluster routers 1311a, 1311b, and 1311c can be based at least in part on the data communication requirements of the computing devices and cluster storage arrays, the data communications capabilities of the network equipment in the cluster routers 1311a, 1311b, and 1311c, the latency and throughput of local networks 1312a, 1312b, 1312c, the latency, throughput, and cost of wide area network links 1313a, 1313b, and 1313c, and/or other factors that can contribute to the cost, speed, fault-tolerance, resiliency, efficiency and/or other design goals of the moderation system architecture.

### Example Methods of Operation

FIG. 14 is a flow chart of an example method 1400. Method 1400 can be carried out by a computing device, such as computing device 1300 discussed above in the context of FIG. 13A.

Method 1400 can begin at block 1410, where a computing device can receive data from one or more data sources, as discussed above in the context of at least FIGS. 1-3, 5, 6, and 8.

At block 1420, the computing device can generate a data frame based on the received data. The data frame can include a plurality of data items, as discussed above in the context of at least FIGS. 3, 5, and 6. In some embodiments, generating the data frame can include storing a subset of the received data in the data frame using a pre-loader, such as discussed above in the context of at least FIG. 3.

At block 1430, the computing device can determine a data ontology. The data ontology can include a plurality of datanodes, as discussed above in the context of at least FIGS. 3 and 5. In some embodiments, the data ontology can be related to a software object hierarchy, such as discussed above in the context of at least FIGS. 4-6 and 8. In other embodiments, the data ontology can be related to a chemical molecule, such as discussed above in the context of at least FIGS. 3 and 8.

At block 1440, the computing device can determine a plurality of data pins, as discussed above in the context of at least FIG. 3. A first data pin of the plurality of data pins can include a first reference and a second reference. The first reference for the first data pin can refer to a first data item in the data frame and the second reference for the first data pin can refers to a first datanode of the plurality of datanodes. The first datanode can be related to the first data item.

At block 1450, the computing device can obtain data for the first data item at the first datanode of the data ontology via the first data pin, as discussed above in the context of at least FIG. 3. In some embodiments, the second reference can refer to a datanode associated with a software object in the software object hierarchy. In other embodiments, determining the data ontology can include parsing the software object hierarchy, such as discussed above in the context of at least FIGS. 4 and 5. In still other embodiments, the plurality of pins can include a control pin, where the control pin indicates a control data item of the plurality of data items, such as discussed above in the context of at least FIG. 3.

At block 1460, the computing device can provide a representation of the data ontology, such as discussed above in the context of at least FIGS. 3 and 8-11. In some embodiments, the representation includes a visual representation, such as discussed above in the context of at least FIGS. 3 and 8-11.

In some embodiments, method 1400 can also include: receiving additional data from the one or more data sources; storing a subset of the additional data in a second data frame, where the second data frame includes the plurality of data items, and where the data in the second data frame differs from data in the first data frame, and changing the first reference of the first data pin to refer to the first data item in the second data frame, as discussed above in the context of at least FIG. 3.

In other embodiments, method 1400 can also include: specifying a designated control for the control data item of the control pin, and after specifying the designated control, generating a data frame associated with the designated control, such as discussed above in the context of at least FIG. 3. In particular embodiments, the designated control can be at least one control selected from the group consisting of a control based on a time, a control based on an identifier, and a control based on a location.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural or singular number, respectively. Additionally, the words “herein,” “above” and “below” and words of similar import, when used in this application, shall refer to this application as a whole and not to any particular portions of this application.

The above description provides specific details for a thorough understanding of, and enabling description for, embodiments of the disclosure. However, one skilled in the art will understand that the disclosure may be practiced without these details. In other instances, well-known structures and functions have not been shown or described in detail to avoid unnecessarily obscuring the description of the embodiments of the disclosure. The description of embodiments of the disclosure is not intended to be exhaustive or to limit the disclosure to the precise form disclosed. While specific embodiments of, and examples for, the disclosure are described herein for illustrative purposes, various equivalent modifications are possible within the scope of the disclosure, as those skilled in the relevant art will recognize.

All of the references cited herein are incorporated by reference. Aspects of the disclosure can be modified, if necessary, to employ the systems, functions and concepts of the above references and application to provide yet further embodiments of the disclosure. These and other changes can be made to the disclosure in light of the detailed description.

Specific elements of any of the foregoing embodiments can be combined or substituted for elements in other embodiments. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

The above detailed description describes various features and functions of the disclosed systems, devices, and methods with reference to the accompanying figures. In the figures, similar symbols typically identify similar components, unless context dictates otherwise. The illustrative embodiments described in the detailed description, figures, and claims are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the ladder diagrams, scenarios, and flow charts in the figures and as discussed herein, each block and/or communication may represent a processing of information and/or a transmission of information in accordance with example embodiments. Alternative embodiments are included within the scope of these example embodiments. In these alternative embodiments, for example, functions described as blocks, transmissions, communications, requests, responses, and/or messages may be executed out of order from that shown or discussed, including substantially concurrent or in reverse order, depending on the functionality involved. Further, more or fewer blocks and/or functions may be used with any of the ladder diagrams, scenarios, and flow charts discussed herein, and these ladder diagrams, scenarios, and flow charts may be combined with one another, in part or in whole.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code and/or related data may be stored on any type of computer readable medium such as a storage device including a disk or hard drive or other storage medium.

The computer readable medium may also include non-transitory computer readable media such as computer-readable media that stores data for short periods of time like register memory, processor cache, and random access memory (RAM). The computer readable media may also include non-transitory computer readable media that stores program code and/or data for longer periods of time, such as secondary or persistent long term storage, like read only memory (ROM), optical or magnetic disks, compact-disc read only memory (CD-ROM), for example. The computer readable media may also be any other volatile or non-volatile storage systems. A computer readable medium may be considered a computer readable storage medium, for example, or a tangible storage device.

Moreover, a block that represents one or more information transmissions may correspond to information transmissions between software and/or hardware modules in the same physical device. However, other information transmissions may be between software modules and/or hardware modules in different physical devices.

Numerous modifications and variations of the present disclosure are possible in light of the above teachings.

1. A method, comprising:
receiving data from one or more data sources at a computing device;
generating a data frame based on the received data using the computing device, the data frame comprising a plurality of data items;
determining a data ontology at the computing device, wherein the data ontology comprises a plurality of datanodes;
determining a plurality of data pins using the computing device, wherein a first data pin of the plurality of data pins comprises a first reference and a second reference, wherein the first reference for the first data pin refers to a first data item in the data frame, wherein the second reference for the first data pin refers to a first datanode of the plurality of datanodes, and wherein the first datanode is related to the first data item;
obtaining, at the computing device, data for the first data item at the first datanode of the data ontology via the first data pin; and
providing a representation of the data ontology using the computing device.

2. The method of claim 1, wherein the representation comprises a visual representation.

3. The method of claim 1, wherein generating the data frame comprises storing a subset of the received data in the data frame using a pre-loader.

4. The method of claim 1, further comprising:
receiving additional data from the one or more data sources;
storing a subset of the additional data in a second data frame, wherein the second data frame comprises the plurality of data items, and wherein the data in the second data frame differs from data in the first data frame; and
changing the first reference of the first data pin to refer to the first data item in the second data frame.

5. The method of claim 1, wherein the data ontology is related to a software object hierarchy.

6. The method of claim 5, wherein the second reference refers to a datanode associated with a software object in the software object hierarchy.

7. The method of claim 5, wherein determining the data ontology comprises parsing the software object hierarchy.

8. The method of claim 1, wherein the plurality of pins comprise a control pin, and wherein the control pin indicates a control data item of the plurality of data items.

9. The method of claim 8, further comprising:
specifying a designated control for the control data item of the control pin; and
after specifying the designated control, generating a data frame associated with the designated control.

10. The method of claim 9, wherein the designated control is at least one control selected from the group consisting of a control based on a time, a control based on an identifier, and a control based on a location.

11. The method of claim 1, wherein the data ontology relates to a chemical molecule.

12. A computing device, comprising:
a processor; and
a tangible computer readable medium configured to store at least executable instructions, wherein the executable instructions, when executed by the processor, cause the computing device to perform functions comprising the method of claim 1.

13. The computing device of claim 12, wherein the tangible computer readable medium is a non-transitory tangible computer readable medium.

14. A tangible computer readable medium configured to store at least executable instructions, wherein the executable instructions, when executed by a processor of a computing device, cause the computing device to perform functions comprising the method of claim 1.

15. The tangible computer readable medium of claim 14, wherein the tangible computer readable medium is a non-transitory tangible computer readable medium.

16. A device, comprising:
means for receiving data from one or more data sources;
means for generating a data frame based on the received data, the data frame comprising a plurality of data items;
means for determining a data ontology, wherein the data ontology comprises a plurality of datanodes;
means for determining a plurality of data pins, wherein a first data pin of the plurality of data pins comprises a first reference and a second reference, wherein the first reference for the first data pin refers to a first data item in the data frame, wherein the second reference for the first data pin refers to a first datanode of the plurality of datanodes, and wherein the first datanode is related to the first data item;
means for obtaining data for the first data item at the first datanode of the data ontology via the first data pin; and
means for providing a representation of the data ontology.
